(19) United States
(12) Patent Application Publication
(10) Pub. No.: US 2024/0178887 A1
(43) Pub. Date: May 30, 2024

(54) ELECTRONIC DEVICE, COMMUNICATION METHOD, STORAGE MEDIUM AND COMPUTER PROGRAM PRODUCT

(71) Applicant: Sony Group Corporation, Tokyo (JP)

(72) Inventors: Jin XU, Beijing (CN); Yuyan PENG, Beijing (CN); Jianfei CAO, Beijing (CN)

(73) Assignee: Sony Group Corporation, Tokyo (JP)

(21) Appl. No.: 18/552,190

(22) PCT Filed: Mar. 29, 2022
(86) PCT No.: PCT/CN2022/083543

§ 371 Date: Sep. 25, 2023

(30) Foreign Application Priority Data
Apr. 2, 2021 (CN) 202110362243.X

(51) Int. Cl. H04B 7/0408; H04B 17/318; H04W 24/10; H04W 72/044

(52) U.S. Cl. CPC H04B 7/0408; H04B 17/318; H04W 24/10; H04W 72/046

(57) ABSTRACT

The present application relates to an electronic device and a method in a wireless communication system. An electronic device for a user equipment UE side, the UE comprising a plurality of antenna panels, the electronic device comprising: a processing circuit configured to: receive one or more downlink reference signals, DL RSs, from a base station via the plurality of antenna panels; and providing a beam report to the base station, the beam report indicating an association of the plurality of antenna panels with the one or more DL RSs, wherein the beam report comprises: a panel state of at least one of the plurality of antenna panels; an index of at least one of the one or more DL RSs received via the at least one antenna panel; and a channel quality measurement result for the at least one DL RS, is disclosed.

### CROSS-REFERENCE TO RELATED APPLICATIONS

The present application claims priority from Chinese patent application entitled “electronic device, communication method, storage medium, and computer program product” filed on Apr. 2, 2021 with the application number of 202110362243.X, the entire contents of which are incorporated herein by reference.

### TECHNICAL FIELD

The present disclosure relates to the field of wireless communications, and in particular, to an electronic device, a communication method, a storage medium, and a computer program product for use in a wireless communication system.

### BACKGROUND ART

Rel-17 of 3GPP for the 5G New Radio (NR) has an important feature of using large-scale antennas and higher frequencies. According to the multi-antenna information theory, if a plurality of antennas are used at the transmitting end and the receiving end of a wireless communication link, the channel capacity of the system can far exceed the transmission capacity limit of a conventional single-antenna system. The use of multiple antenna panels at user equipment (UE) is a trend. The increase in the antenna scale results in narrower beam width, and puts higher requirements on the performance of beam management of the system.

### SUMMARY OF THE INVENTION

The present disclosure provides an electronic device and a method in a wireless communication system, which can improve beam management in the wireless communication system.

An aspect of the present disclosure relates to an electronic device for a user equipment UE side, the UE including a plurality of antenna panels, comprising: a processing circuit configured to: receive one or more downlink reference signals, DL RS, from a base station via the plurality of antenna panels; and providing a beam report to the base station, the beam report indicating an association of the plurality of antenna panels with the one or more DL RSs, wherein the beam report comprises: a panel state of at least one antenna panel of the plurality of antenna panels; an index of at least one of the one or more DL RSs received via the at least one antenna panel; and a channel quality measurement result for the at least one DL RS.

Another aspect of the present disclosure relates to an electronic device for a base station BS side, comprising: a processing circuit configured to: transmit one or more downlink reference signals, DL RS, to a user equipment, UE, comprising a plurality of antenna panels; and receive a beam report from the UE, wherein the beam report includes: a panel state of at least one antenna panel of the plurality of antenna panels; an index of at least one of the one or more DL RSs received via the at least one antenna panel; and a channel quality measurement result for the at least one DL RS.

Another aspect of the present disclosure relates to an electronic device for a user equipment UE side, the UE including a plurality of antenna panels, comprising: a processing circuit configured to: receive, from a base station, sounding reference signal, SRS, configuration that configures a plurality of SRS resource sets for the UE; providing SRS-antenna panel association information to the base station, the SRS-antenna panel association information including: a panel state of each of the plurality of antenna panels; and an index of a corresponding SRS resource set to be transmitted via the antenna panel or an index of any SRS in the corresponding SRS resource set to be transmitted via the antenna panel; and transmit, to the base station, the SRS in the corresponding SRS resource set via at least one of the plurality of antenna panels based on the SRS-antenna panel association information.

Yet another aspect of the present disclosure relates to an electronic device for a base station BS side, comprising: a processing circuit configured to: transmit sounding reference signal SRS configuration to user equipment UE, wherein the SRS configuration configures a plurality of SRS resource sets for the UE; receive, from the UE, SRS-antenna panel association information including: a panel state of each of a plurality of antenna panels of the UE; and an index of a corresponding SRS resource set to be transmitted via the antenna panel or an index of any SRS in the corresponding SRS resource set to be transmitted using the antenna panel; and receive, from the UE, one or more SRS from the plurality of SRS resource sets.

Another aspect of the present disclosure relates to a method performed at the UE side, which may include operations performed by the processing circuit of the aforementioned electronic device at the UE side.

Another aspect of the present disclosure relates to a method performed at the BS side, which may include operations performed by the processing circuit of the aforementioned electronic device at the UE side.

Another aspect of the disclosure relates to a computer-readable storage medium having one or more instructions stored thereon, which when executed by one or more processing circuits of an electronic device, cause the electronic device to perform the method as described above.

Another aspect of the disclosure relates to a computer program product comprising a computer program which, when executed by a processor, carries out the steps of the method as described above.

### BRIEF DESCRIPTION OF THE DRAWINGS

The above-mentioned and other objects and advantages of the present disclosure will be further described in conjunction with the specific embodiments with reference to the accompanying drawings. In the drawings, identical or corresponding features or components will be indicated by identical or corresponding reference signs.

FIG. 1 illustrates a schematic diagram of a wireless communication system according to an embodiment of the disclosure.

FIG. 2 illustrates a block diagram of an electronic device according to an embodiment of the disclosure.

FIG. 3 illustrates an exemplary flowchart of a method in accordance with an embodiment of the disclosure.

FIG. 4A illustrates an example of a mapping relationship between an antenna panel and a DL RS according to an embodiment of the present disclosure.

FIG. 4B illustrates another example of a mapping relationship between an antenna panel and a DL RS according to an embodiment of the present disclosure.

FIG. 4C illustrates yet another example of a mapping relationship between an antenna panel and a DL RS according to an embodiment of the present disclosure.

FIG. 4D illustrates still another example of a mapping relationship between an antenna panel and a DL RS according to an embodiment of the present disclosure.

FIG. 5 illustrates an example flowchart of a method in accordance with an embodiment of the disclosure.

FIG. 6 illustrates an example flowchart of a method in accordance with an embodiment of the disclosure.

FIG. 7 illustrates a schematic diagram of updating an association between an antenna panel and a DL RS according to an embodiment of the present disclosure.

FIG. 8 illustrates an exemplary signaling flowchart for transmitting an updated beam report in accordance with an embodiment of the disclosure.

FIG. 9 illustrates an exemplary signaling flowchart for transmitting an updated beam report in accordance with an embodiment of the disclosure.

FIG. 10 illustrates an exemplary flowchart of a method in accordance with an embodiment of the disclosure.

FIG. 11 illustrates an exemplary flowchart of a method in accordance with an embodiment of the disclosure.

FIG. 12 shows a schematic diagram for associating an SRS resource set with an antenna panel according to an embodiment of the disclosure.

FIG. 13 illustrates an exemplary flowchart of a method in accordance with an embodiment of the disclosure.

FIG. 14 is a block diagram schematically illustrating an exemplary structure of a personal computer of an information processing apparatus employable in an embodiment according to the present disclosure;

FIG. 15 is a block diagram illustrating a first example of a schematic configuration of an eNB to which techniques of the disclosure may be applied;

FIG. 16 is a block diagram illustrating a second example of a schematic configuration of an eNB to which techniques of the disclosure may be applied;

FIG. 17 is a block diagram illustrating an example of a schematic configuration of a communication device to which techniques of the present disclosure can be applied, and

FIG. 18 is a block diagram illustrating an example of a schematic configuration of a car navigation device to which techniques of the present disclosure can be applied.

While the embodiments described in the disclosure may be susceptible to various modifications and alternative forms, specific embodiments thereof have been shown by way of example in the drawings and are herein described in detail. It should be understood, however, that the drawings and detailed description thereto are not intended to limit the embodiments to the particular form disclosed, but on the contrary, its purpose is to cover all modifications, equivalents and alternatives falling within the spirit and scope of the claims.

### DETAILED DESCRIPTION

Exemplary embodiments of the present disclosure will be described hereinafter with reference to the accompanying drawings. For clarity and conciseness, not all features of an embodiment have been described in the specification. It should be appreciated, however, that when implementing the embodiments, numerous settings specific to the embodiments must be made to achieve the developers' specific goals, such as conformation to limitation conditions associated with devices and services, which may vary from one embodiment to another. Moreover, it will be appreciated that such a development effort might be complex and time-consuming, but would nevertheless be a routine undertaking for those of ordinary skill in the art benefiting from the present disclosure.

Here, it should also be noted that, in order to avoid obscuring the present disclosure with unnecessary details, only process steps and/or device structures closely related to at least the scheme according to the present disclosure are shown in the drawings, and other details not so related to the present disclosure are omitted.

The basic technical concept and exemplary embodiments of the wireless communication system of the present disclosure will be described below with reference to the accompanying drawings.

### 1. Example Wireless Communication System and Example Electronic Device

FIG. 1 illustrates a schematic diagram of a wireless communication system 100 according to an embodiment of the disclosure. Various techniques described in the disclosure may be performed within wireless communication system 100. The wireless communication system 100 may include a base station 110 and a UE 120. It should be appreciated that although only one base station 110 and three UEs 120 are illustrated in FIG. 1, it should be appreciated that the wireless communication system 100 may include any other suitable number of base stations and UEs.

The base station 110 is an example of a network-side device in the wireless communication system 100. In the disclosure, the terms “base station” and “network-side device” may be used interchangeably. Any network side device may be used to implement the operation of the base station 110 in a substitutive manner. Base station 110 may be implemented as any type of base station. For example, base station 110 may be implemented as eNBs, such as macro eNBs and small eNBs. Small eNBs may be eNBs that cover cells smaller than macro cells, such as pico eNBs, micro eNBs, and home (femto) eNBs. For another example, base station 110 may also be implemented as gNBs, such as macro gNBs and small gNBs. The small gNB may be gNBs covering a cell smaller than a macro cell, such as pico gNBs, micro gNBs, and home (femto) gNBs. Alternatively, the base station may be implemented as any other type of base station, such as a NodeB and a Base Transceiver Station (BTS).

UE 120 is an example of a user side device in wireless communication system 100. UE 120 may be implemented as any type of terminal device. For example, the UE 120 may be implemented as a mobile terminal such as a smart phone, a tablet personal computer (PC), a notebook PC, a portable game terminal, a portable/dongle-type mobile router, and a digital camera, or a vehicle-mounted terminal such as a car navigation device. For another example, the UE 120 may also be implemented as a terminal that performs machine-to-machine (M2M) communication (also referred to as a Machine Type Communication (MTC) terminal). Further, the UE 120 may be a wireless communication module (such as an integrated circuit module including a single wafer) mounted on each of the above-described terminals.

Base station 110 and UE 120 may perform wireless communications according to any suitable communication protocol. For example, the wireless communication may be performed according to a cellular communication protocol. Cellular communication protocols may include 4G, 5G, and any cellular communication protocol under development or yet to be developed.

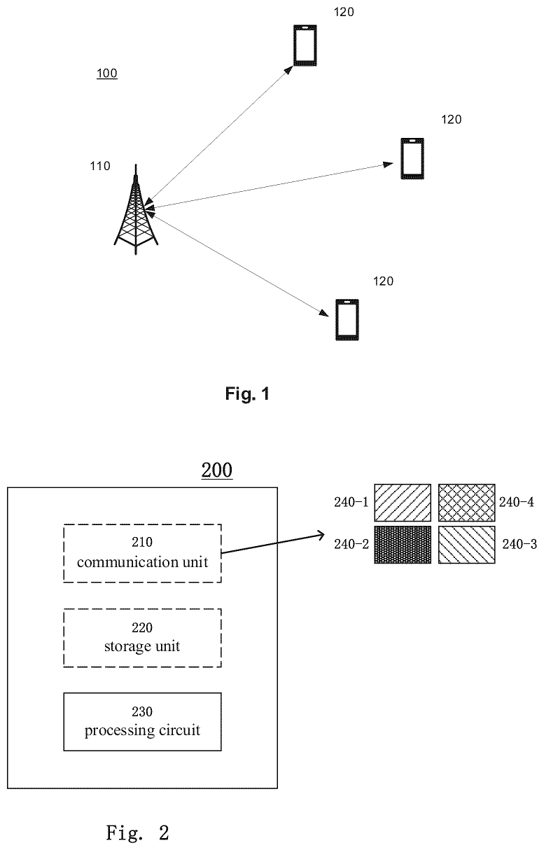

FIG. 2 shows a block diagram of an electronic device 200 according to an embodiment of the disclosure. The electronic device 200 may comprise a communication unit 210, a storage unit 220, and a processing circuit 230.

The communication unit 210 may be used to receive or transmit radio transmissions. For example, the radio transmission may include a downlink transmission from the base station 110 to the UE 120 and/or an uplink transmission from the UE 120 to the base station 110. The radio transmission may be used to transmit various control signaling (e.g., radio resource control (RRC), downlink control information (DCI), uplink control information (UCI)), and/or user data. The radio transmission may also be used to transmit one or more synchronization signals, reference signals, or measurement signals, such as a synchronization signal block (SSB), a channel state information reference signal (CSI-RS), a sounding reference signal (SRS), and so on. Communication unit 210 may perform functions such as up-conversion, digital-to-analog conversion, etc. on transmitted radio signals and/or perform functions such as down-conversion, analog-to-digital conversion, etc. on received radio signals. In embodiments of the present disclosure, the communication unit 210 may be implemented using various technologies. For example, the communication unit 210 may be implemented as communication interface components such as an antenna device, a radio frequency circuit, and a partial baseband processing circuit. The communication unit 210 is depicted with dashed lines, as it may alternatively be located within the processing circuit 230 or outside the electronic device 200.

The storage unit 220 may store information generated by the processing circuit 230, information received from or to be transmitted to other devices through the communication unit 210, programs, machine codes, data, and the like for the operation of the electronic device 200. The storage unit 220 may be a volatile memory and/or a non-volatile memory. For example, the storage unit 220 may include, but is not limited to, a random access memory (RAM), a dynamic random access memory (DRAM), a static random access memory (SRAM), a read only memory (ROM), and a flash memory. The memory unit 220 is depicted with dashed lines, since it may alternatively be located within the processing circuit 230 or outside the electronic device 200.

The processing circuitry 230 may be configured to perform one or more operations to provide various functions of the electronic device 200. As an example, the processing circuit 230 may perform corresponding operations by executing one or more executable instructions stored by the storage unit 220. For example, when the electronic device 200 is used to implement a base station side device as described in the present disclosure, the processing circuit 230 may be configured to perform one or more base station-side operations as described in the present disclosure. When the electronic device 200 is used to implement an UE-side device as described in the present disclosure, the processing circuitry 230 may be configured to perform one or more operations of the UE-side as described in the present disclosure. Electronic device 200, and more particularly processing circuitry 230, may be used to perform one or more of the operations described herein in relation to base station 110. In this case, the electronic device 200 may be implemented as the base station 110 itself, a part of the base station 110, or a control device for controlling the base station 110. For example, the electronic device 200 may be implemented as a chip for controlling the base station 110. Further, electronic device 200 (and more particularly processing circuitry 230) may also be used to perform one or more of the operations described herein in relation to UE 120. In this case, the electronic device 200 may be implemented as the UE 120 itself, a part of the UE 120, or a control device for controlling the UE 120. For example, the electronic device 200 may be implemented as a chip for controlling the UE 120.

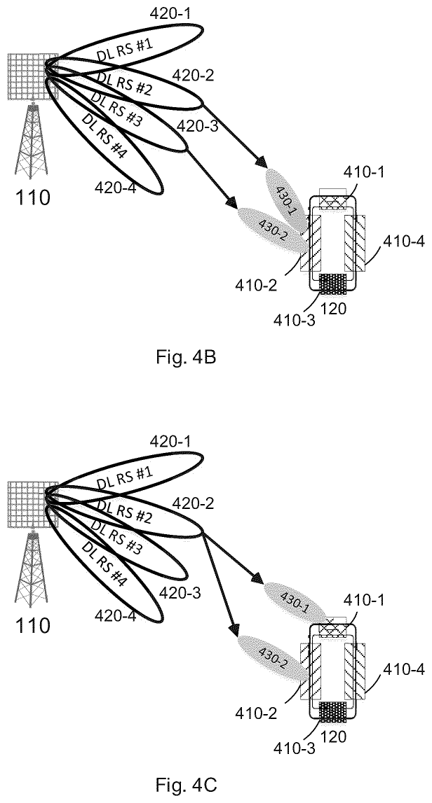

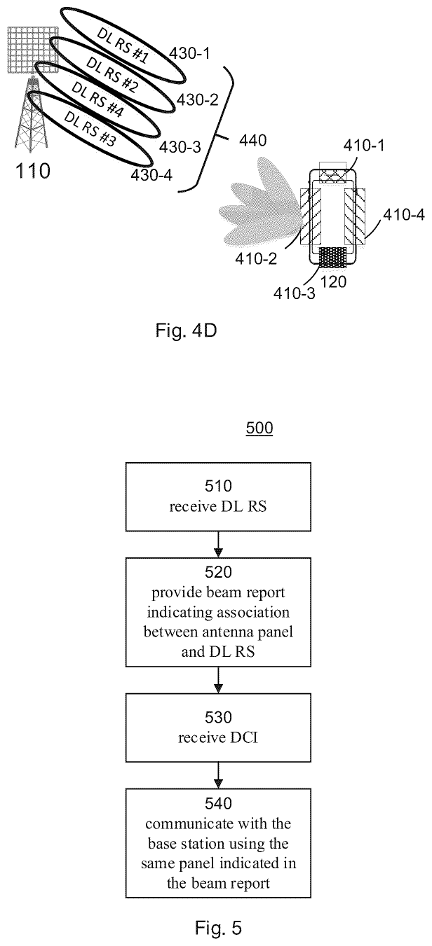

When the electronic device 200 is implemented as the UE 120 itself, the communication unit 210 of the electronic device 200 includes a plurality of antenna panels, such as the antenna panels 240-1 to 240-4 shown in FIG. 2. Although four antenna panels are shown in FIG. 4, it should be appreciated that there may be any one or more antenna panels. Each antenna panel may include one or more antenna elements. Each antenna panel may have independent transceiver circuitry and thus may form receiving or transmitting beams independently of one another. The individual antenna panels may have the same or different sizes of antenna arrays.

It should be noted that the various units described above are exemplary and/or preferred modules for implementing the processes described in the disclosure. The modules may be hardware units (such as a central processing unit, a field programmable gate array, a digital signal processor, or an application specific integrated circuit, etc.) and/or software modules (such as a computer readable program). The above does not describe in detail the modules for implementing the various steps described below. However, as long as there is a step of performing a certain process, there may be a corresponding module or unit (implemented by hardware and/or software) for implementing the same process. Technical solutions defined by all combinations of steps described below and units corresponding to the steps are included in the disclosure of the present disclosure as long as the technical solutions composed by them are complete and applicable.

Further, a device composed by various units may be incorporated as a functional module into a hardware device such as a computer. In addition to these functional modules, the computer may of course have other hardware or software components.

Example embodiments of the present disclosure will be further described below in conjunction with the appended drawings. It should be noted that in the following description, various methods performed at the base station side may be performed by the processing circuit 230 of the electronic device 200 implemented at the base station side. For convenience, this method is described below as being performed by the base station 110. However, those skilled in the art will appreciate that these methods may also be performed by a part of the base station 110 or by a control device of the base station 110. Further, various methods performed at the UE side may be performed by the processing circuit 230 of the electronic device 200 implemented at the UE side. For convenience, this method is described below as being performed by the UE 120. However, those skilled in the art will recognize that these methods may also be performed by a portion of UE 120 or by a controlling device of UE 120.

Existing beam management and beam selection rely solely on measurements of reference signals and are performed at the base station. In case of a UE with a multi-antenna panel, the panel selection is also referred to as part of beam management. The UE needs to quickly select a suitable antenna panel when receiving downlink transmissions or sending uplink transmissions. Moreover, since the base station cannot be timely aware of the change in the state of the antenna panel at the UE, the selection made relying only on reference signal measurements may not be optimal. There is a need for an improved beam management solution to solve at least one of the above-mentioned problems.

2. Association of Downlink Reference Signals with an Antenna Panel

### 2.1 Association Reporting

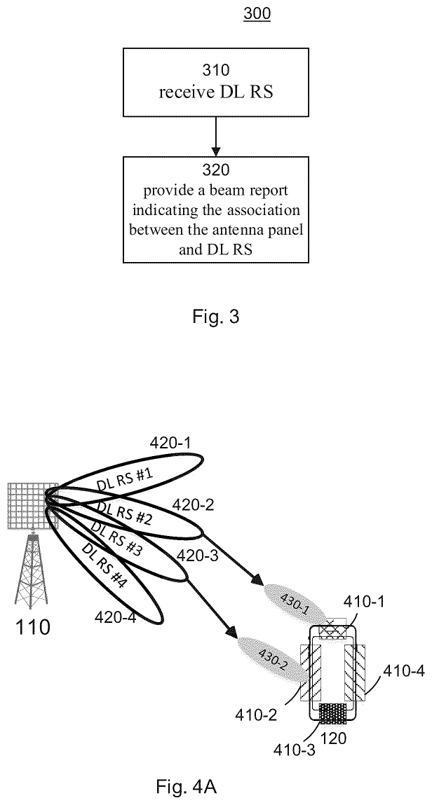

FIG. 3 illustrates an example flowchart of a method in accordance with an embodiment of the disclosure. Method 300 may be used to implement a scheme of association of downlink reference signals with antenna panels according to embodiments of the present disclosure. Method 300 may be performed at the UE 120 side. Method 300 may include steps 310 to 320.

In step 310, UE 120 may be configured to receive one or more downlink reference signals (DL RSs) from a base station via a plurality of antenna panels.

The antenna panels of UE 120 may have different panel states. In some embodiments, the panel state may be any one of the following states: (1) “inactivated”; (2) “partially activated for downlink measurements only”; (3) “partially activated for downlink measurements and data transmission only” and (4) “fully activated”. “Inactivated” means that the antenna panel is turned off and cannot receive/transmit any radio signal. “Partially activated for downlink measurements only” means that the antenna panel does not support downlink data transmission and uplink transmission. “Partially activated for downlink measurements and data transmission only” means that the antenna panel does not support uplink transmission. “Fully activated” means that the antenna panel supports both downlink reception and uplink transmission.

UE 120 may change the panel states of its antenna panels depending on factors such as rotation, movement, channel blockage, maximum power exposure (MPE) requirements, power control, and so on, of the device. For example, a plurality of antenna panels may be located at different locations of the device of UE 120. When UE 120 is in a first device posture or position, an antenna panel in a first position may provide a better beam relative to the base station while an antenna panel in a second position may not provide a better beam. At this point, UE 120 may partially or fully activate (e.g., turn on) the antenna panel at the first location and turn off the antenna panel at the second location. Whereas when UE 120 changes to a second device posture or position due to rotation or movement, an antenna panel located at the second position will provide a better beam relative to the base station. At this point, the UE 120 may deactivate (e.g., turn off) the antenna panel at the first location, while partially activating or fully activating the antenna panel at the second location. For another example, when multiple antenna panels perform uplink transmission simultaneously and interfere with each other or interfere with transmissions of other UEs to cause congestion, UE 120 may selectively turn off the uplink transmission function of some antenna panels. For another example, when UE 120 is close to the human body, the antenna panel in the UE that is closer to the human body may be turned off in consideration of meeting the MPE requirements. For another example, some antenna panels may be turned off or partially turned off for power saving when UE 120 is power limited.

In some embodiments, each DL RS received by UE 120 may be a channel state information reference signal, CSI-RS, or a synchronization signal block, SSB. The CSI-RS is used for channel sounding. Both CSI-RS and SSB may be used for beam management. The CSI-RS may be transmitted from the base station to the UE in a periodic, semi-continuous, or aperiodic manner. Semi-persistent CSI-RS requires the base station to send MAC control elements (MAC CEs) to activate/deactivate. The aperiodic CSI-RS needs to be triggered by the base station through downlink control information, DCI.

In some embodiments, the DL RSs received by UE 120 may be a CSI-RS resource set whose repetition parameter, Repetition, is configured to be “ON”. The value of the repetition parameter may indicate whether all CSI-RSs in the corresponding CSI-RS resource set correspond to the same beam. Repetition configured to be an ON value means that all CSI-RSs in the corresponding CSI-RS resource set correspond to the same beam. Repetition configured to an OFF value means that all CSI-RSs in the corresponding CSI-RS resource set correspond to different beams. As will be described later, a CSI-RS resource set with the Repetition parameter configured to be ON is advantageous when used for the optimization of the received beam at the UE. In some embodiments, the DL RSs received by UE 120 may be an SSB resource set.

UE 120 may autonomously decide in which way multiple antenna panels are used to receive the DL RS. Typically, UE 120 receives each DL RS using a different antenna panel. In other embodiments, UE 120 may be configured to receive multiple DL RSs using one antenna panel and/or receive one DL RS using multiple antenna panels. That is, the mapping relationship between the antenna panels and the DL RSs may be one-to-one, one-to-many, and many-to-one. UE 120 may determine which mapping relationship to use specifically based on various factors such as the number of DL RS ports, the number of antenna panels, transmission beam width of the base station, reception beam width of the antenna panels, and so on. The mapping relationship may change during the operation of the UE.

In step 320, UE 120 is configured to provide a beam report that can indicate association between multiple antenna panels and one or more DL RSs to the base station. Specifically, the beam report includes a panel state of at least one antenna panel among a plurality of antenna panels of UE 120, an index of DL RS received via the at least one antenna panel, and a channel quality measurement result for the DL RS.

In some embodiments, the beam report includes, for each of all antenna panels of UE 120, a corresponding panel state, an index of a DL RS received by the antenna panel, and a channel quality measurement result for the DL RS. If the panel state of an antenna panel is “inactivated”, the index of the received DL RS and the channel quality measurement result for the DL RS are both null values.

In other embodiments, the beam report may be only for those antenna panels capable of receiving DL RSs, i.e., antenna panels whose panel states are not “inactivated”, thereby reducing the transmission resource overhead required for beam reporting.

For a CSI-RS, its index may be a channel state information resource indicator (CRI). For an SSB, the index may be a synchronization signal block resource indicator (SSBRI). For a CSI-RS resource set and an SSB resource set, their indexes may be the corresponding resource set identifications (IDs), respectively.

In some embodiments, the channel quality measurement result for the DL RS is Layer 1 Reference Signal Received Power (L1-RSRP) or Layer 1 Signal to Interference plus Noise Ratio (L1-SINR). Compared with the requirement of high-layer signaling to report, the channel quality can be fed back to the base station quickly by utilizing L1-RSRP or L1-SINR.

In some embodiments, the beam report may further optionally include a panel ID or label for identifying the antenna panel. The panel ID is different from the label in that the panel ID may reflect the specific implementations of the corresponding antenna panel, such as the size of the antenna array, while this information may be hidden from the label. Note that while the panel ID or label may make it convenient for the base station to directly know the specific antenna panel, the panel ID or label is not mandatory in the beam report. By including the panel states of the antenna panels and the indexes of the corresponding DL RSs in the beam report, the base station is enabled to know the existence of the association between the antenna panels and the DL RSs, and can use the association for beam indication in subsequent downlink or uplink transmissions.

As previously described, in some embodiments, UE 120 is configured to receive each DL RS with a different antenna panel, at which time the beam report includes, for each antenna panel used to receive the DL RSs, its panel state, the index of the DL RS received by that antenna panel, and the channel quality measurement result for that DL RS.

FIG. 4A shows an example of a mapping relationship between antenna panels and DL RSs, where one antenna panel is used to receive only one DL RS, according to an embodiment of the present disclosure. As shown in FIG. 4A, UE 120 has four antenna panels 410-1 to 410-4, where only antenna panels 410-1 and 410-2 are fully or partially activated for downlink measurements. The base station 110 is configured with four DL RS ports, corresponding to four DL RS beams 420-1 to 420-4, respectively. Since UE 120 has determined in advance that the antenna panel is used for receiving only one DL RS beam, the situation shown in FIG. 4A may occur in actual reception, i.e., beam 420-2 is received by antenna panel 410-1 and beam 420-3 is received by antenna panel 410-2. The reception beams 430-1 and 430-2 used by antenna panels 410-1 and 410-2 to receive respective DL RSs may be default or selected in advance.

Antenna panels 410-1 and 410-2, upon receiving DL RS beams 420-2 and 420-3, measure the DL RS beams 420-2 and 420-3 and provide beam reports to the base station. Table 1 shows a signaling format example of a corresponding beam report. Each entry of beam report signaling corresponds to each antenna panel receiving a DL RS. In this example, entry 1 corresponds to antenna panel 410-1 and entry 2 corresponds to antenna panel 410-2. The order between the entries can be set arbitrarily. For each entry, i.e., for each antenna panel, the beam report signaling includes an index of a DL RS received by the antenna panel, a channel quality measurement result of the DL RS, and a panel state of the antenna panel. The index of the DL RS may be determined by the UE based on the RRC parameter CSI-ResourceConfig provided by the base station. The RRC parameter CSI-ResourceConfig is used to indicate to the UE how the CSI-RS resource is configured. Antenna panel 410-1 in Table 1 correspondingly receives DL RS #2 with a channel quality measurement result of L1 RSRP #2 and a panel state of “fully activated”.

Optionally, the beam signaling report further includes a panel ID or label of the antenna panel. As shown in Table 1, what included in the entry of antenna panel 410-1 is label “P1”, which does not reflect a particular implementation of the antenna panel; what included in the entry of antenna panel 410-2 is panel ID “P2-2*4”, where “2*4” indicates that antenna panel 410-2 includes 2*4 antenna arrays. While it is shown in Table 1 that different entries may use panel IDs or labels, respectively, in other embodiments, the entries may use panel IDs uniformly, or labels uniformly.

TABLE 1
example of beam report corresponding to FIG. 4A

| | | Channel quality | | Panel |
|---|---|---|---|---|
| | DL RS | measurement | | ID/label |
| | index | results | Panel state | (optional) |
| Entry 1: | DL RS #2 | L1 RSRP #2 | Fully activated | P1 |
| Entry 2: | DL RS #3 | L1 RSRP #2 | partially activated | P2-2*4 |
| | | | for DL measure- | |
| | | | ments only | |

FIG. 4B illustrates another example of a mapping relationship between antenna panels and DL RSs, where one antenna panel is used to receive multiple DL RSs, according to an embodiment of the present disclosure. As shown in FIG. 4B, unlike FIG. 4A, antenna panel 410-2 is determined in advance to be able to receive two DL RS beams, e.g., DL RS beams 420-2 and 420-3.

In some embodiments, when UE is configured to receive a plurality of DL RSs with the same antenna panel, the beam report includes a panel state of the same antenna panel, an index of a DL RS having the best channel quality measurement result among the plurality of DL RSs, and the best channel quality measurement result. Table 2-1 shows a signaling format example of the corresponding beam report. In Table 2-1, the channel quality measurement result L1 RSRP #2 corresponding to the DL RS beam 420-2 is better than the channel quality measurement result L1 RSRP #3 corresponding to the DL RS beam 420-3. Therefore, only “DL RS #2” and “L1 RSRP #2” may be included in the entry 1 corresponding to the antenna panel 410-2.

TABLE 2-1
example of beam report corresponding to FIG. 4B

| | | Channel quality | | Panel |
|---|---|---|---|---|
| | DL RS | measurement | | ID/label |
| | index | result | Panel state | (optional) |
| Entry 1: | DL RS #2 | L1 RSRP #2 | Fully activated | P1 |

In other embodiments, when the UE is configured to receive a plurality of DL RSs with the same antenna panel, the beam report includes, for each of the plurality of DL RSs, a panel state of the same antenna panel, a group label shared by the plurality of DL RSs, an index of the DL RS, and a corresponding channel quality measurement. Table 2-2 shows a signaling format example of the corresponding beam report. Unlike Table 2-1, Table 2-2 includes corresponding entries, namely entry 1 and entry 2, for DL RS beams 420-2 and 420-3, respectively, received by antenna panel 410-2. Entry 1 and entry 2 share the same group label “G1”, thereby indicating that these two entries correspond to the same antenna panel.

TABLES 2-2
example of beam report corresponding to FIG. 4B

| | | Channel quality | | | Panel |
|---|---|---|---|---|---|
| | DL RS | measurement | | Group | ID/label |
| | index | results | Panel state | label | (optional) |
| Entry 1: | DL RS #2 | L1 RSRP #2 | Fully | G1 | P2-2*4 |
| | | | activated | | |
| Entry 2: | DL RS #3 | L1 RSRP #3 | Fully | G1 | P2-2*4 |
| | | | activated | | |

FIG. 4C illustrates another example of a mapping relationship between antenna panels and DL RSs, where one DL RS is received by a plurality of antenna panels, according to an embodiment of the present disclosure. As shown in FIG. 4C, antenna beam 420-2 is received simultaneously by two antenna panels 410-1 and 410-2. In this case, the antenna panels 410-1 and 410-2 may be regarded as one virtual panel. The UE may combine and report the channel quality measurement results measured by each antenna panel in the virtual panel. The combination of the channel quality measurement results may take various forms depending on the situation, and may include, for example, taking a linear average. Table 3 shows a signaling format example of the corresponding beam report. The channel quality measurement results, panel states, and panel IDs/labels (if any) for antenna panels 410-1 and 410-2, respectively, are combined in entry 1. Although it is shown in Table 3 that the two antenna panels 410-1 and 410-2 used as one virtual panel have different panel states, in other embodiments, the respective antenna panels used as one virtual panel may be set to have the same panel state for convenience of management and use. In some cases, the UE may preferentially select multiple antenna panels with the same panel state to be used as a virtual panel.

TABLE 3
example of beam report corresponding to FIG. 4C

| | | Channel quality | | Panel |
|---|---|---|---|---|
| | DL RS | measurement | | ID/label |
| | index | results | Panel state | (optional) |
| Entry 1: | DL RS #2 | (L1 RSRP #2 | (fully activated; | P1, P2 |
| | | measured by P1; | partially activated | |
| | | RSRP #2 | for DL measure- | |
| | | measured by P2) | ments only) | |

FIG. 4D shows another example of a mapping relationship between antenna panels and DL RSs according to an embodiment of the present disclosure, where multiple DL RSs are a resource set with the same beam direction, such as a CSI-RS resource set or an SSB resource set of which the repetition parameter, Repetition, is configured to be ON. As shown in FIG. 4D, multiple DL RS beams 430-1 to 430-4 in the DL RS resource set 440 have the same beam direction. UE 120 may generate four different receiving beams, corresponding to DL RS beams 430-1 to 430-4, using one antenna panel 410-2, so that an optimal receiving beam may be determined through measurements. Due to the channel reciprocity of the uplink and downlink, this optimal receiving beam can also be used for uplink transmission by the UE. Table 4 shows a signaling format example of the corresponding beam report. Entry 1 corresponds to antenna panel 410-2 for receiving DL RS resource set 440. The DL RS index is an index of DL RS resource set 440 (e.g., CSI-RS resource set ID or SSB resource set ID). The UE 120 can include measurement results for each DL RS beam in the beam report, and can also include an optimal channel quality measurement result for DL RS resource set 440 measured by each receiving beam in the beam report.

TABLE 4
example of beam report corresponding to FIG. 4D

| | | | |
|---|---|---|---|
| | Channel quality | | Panel |
| DL RS | measurement | | ID/label |
| index | results | Panel state | (optional) |

| | | | |
|---|---|---|---|
| Entry 1: | DL RS | Optimal L1- | partially activated |
| | resource | RSRP | for DL measure- |
| | set #1 | | ments only |

### 2.2 Utilization of the Association

FIG. 5 illustrates an example flowchart of a method 500 in accordance with an embodiment of the disclosure. Method 500 may be used to implement a scheme for antenna panel selection using association between downlink reference signals and antenna panels in accordance with an embodiment of the present disclosure. As with method 300, method 500 may be performed at the UE 120 side. The method 500 may include steps 510 to 540, wherein steps 510 and 520 are the same as steps 310 and 320 in FIG. 3, and are not repeated herein.

In step 530, UE 120 is configured to receive DCI from a base station. The DCI indicates a DL RS selected by the base station among one or more DL RSs previously transmitted by the base station to the UE for channel sounding or beam management (see step S310). The selection of the DL RS may be made by the base station based on the channel quality measurement result and the panel state in the beam report (see step S320). For example, the base station may select the DL RS corresponding to the best channel quality measurement result in the beam report. However, if the panel state corresponding to the best channel quality measurement result is “partially activated for downlink measurement only”, i.e. the corresponding antenna panel does not support downlink or uplink data transmission, the base station may further select the DL RS corresponding to the suboptimum channel quality measurement result and check the corresponding panel state as well, and so on, until finding the DL RS corresponding to the antenna panel capable of supporting downlink and/or uplink transmission. It can be appreciated that including the panel state in the beam report facilitates the base station to select a more suitable DL RS and, thus, a more suitable panel. After selecting the DL RS, the base station includes information of the DL RS in DCI for transmitting to the UE.

In step 540, UE 120 is configured to communicate with the base station using the same antenna panel indicated in the beam report for receiving the selected DL RS. Specifically, after acquiring the information of the DL RS selected by the base station from the received DCI, UE 120 may know that the base station will use the same transmission beam as the selected DL RS in subsequent transmissions, and accordingly, UE 120 also uses the same antenna panel previously used for receiving the selected DL RS to receive the transmission beam. Depending on the uplink and downlink reciprocity, the base station may also use the same receiving beam as the selected DL RS in subsequent transmissions. Accordingly, UE 120 may also perform transmission using the same antenna panel previously used to receive the selected DL RS. It can be appreciated that since the association between the DL RS and the antenna panel is indicated in the beam report, the base station performs panel selection indirectly by indicating the DL RS.

### 2.3 Updated Association Reporting

In some cases, as mentioned above, due to factors such as rotation, movement, communication blocking, MPE or power control of the UE, the state of the antenna panels of the UE may change accordingly, or the channel quality measurement results measured by the antenna panel become very poor, and at that point the association relationship between the antenna panels and the DL RSs, which has been reported to the base station, is no longer applicable. The UE may receive a transmission beam indicated by a previous DL RS or receive a transmission beam indicated by a new DL RS using a new antenna panel. The inventors of the present disclosure have recognized that it is advantageous for the UE to actively initiate reporting of association updates between DL RSS and antenna panels, since the UE can detect information such as antenna panel state, rotation, movement, traffic congestion, MPE status, or power control more timely than the base station.

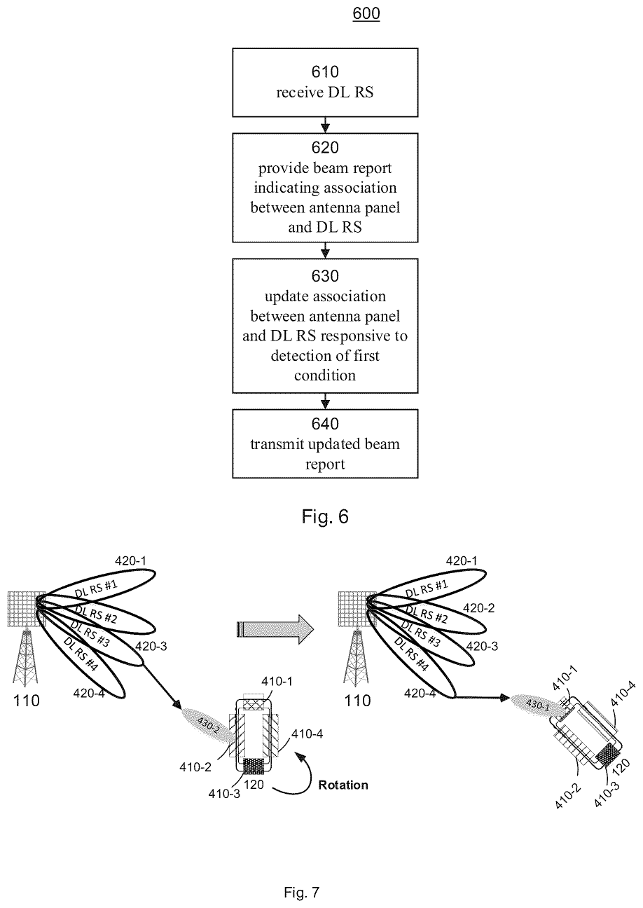

FIG. 6 illustrates an example flowchart of a method 600 in accordance with an embodiment of the disclosure. The method 600 may be used to implement a scheme for reporting an update of an association between a downlink reference signal and an antenna panel according to an embodiment of the present disclosure. Like the method 600, the method 600 may be performed at the UE 120 side. The method 600 may include steps 610 to 640, where steps 610 and 620 are the same as steps 310 and 320 in FIG. 3, and are not repeated herein.

In step 630, the UE 120 is configured to update the association between the antenna panel and the DL RS in response to detecting the first condition.

The first condition may indicate that the association between the antenna panel and the DL RS should be changed. In some embodiments, the first condition comprises a change in a panel state of the antenna panel. For example, an antenna panel that was originally used to receive the downlink beam may need to be turned off due to power control. In some embodiments, the first condition comprises a channel quality measurement result for the DL RS being less than a predetermined threshold.

Updating the association between the antenna panel and the DL RS may include: (1) receiving the original DL RS in the beam report (e.g., provided in step 320) using a new antenna panel; (2) receiving a new DL RS using the new antenna panel; or (3) receiving the new DL RS using the original antenna panel in the beam report (e.g., provided in step 320). Note that here “new antenna panel” and “new DL RS” are both relative to the antenna panel and DL RS already associated in the beam report. As long as a new association relationship is formed by the “new antenna panel” or the “new DL RS” substituting the original antenna panel or DL RS in the beam report, it can be considered that the association between the antenna panel and the DL RS is updated.

In step 640, the UE 120 is configured to transmit an updated beam report to the base station to indicate the updated association between the antenna panel and the DL RS.

The updated beam report may have the same signaling format as the original beam report (e.g., provided in step 320). Specifically, the updated beam report may include the states of the antenna panels, the indexes of the DL RSs received by the antenna panels, and the channel quality measurement results for the DL RSs. The updated beam report may also optionally include panel IDs or labels as well. For example, the updated beam report may have similar signaling formats shown in Table 1, Table 2-1, Table 2-2, Table 3, and Table 4 above. If updating the association between the antenna panel and the DL RS comprises receiving the original DL RS using a new antenna panel, the state of the antenna panel in the updated beam report may be a panel state of the new antenna panel, an index of the original DL RS, and a channel quality measurement result for the original DL RS measured by using the new antenna panel. If updating the association between the antenna panel and the DL RS includes receiving a new DL RS using a new antenna panel, the updated beam report may include a panel state of the new antenna panel, an index of the new DL RS, and a channel quality measurement result for the new DL RS. If updating the association between the antenna panel and the DL RS comprises receiving a new DL RS using the original antenna panel, the updated beam report may include the original antenna panel state, the index of the new DL RS, and the channel quality measurement result for the new DL RS.

FIG. 7 shows a schematic diagram of an update of association between an antenna panel and a DL RS according to an embodiment of the present disclosure. FIG. 7 is an extension of FIG. 4, the reference signs in FIG. 7 having the same meaning as those of FIG. 4. As shown on the left side of FIG. 7, antenna panel 410-2 has established an association with DL RS beam 420-3. As a result of the flipping occurred to UE 120, antenna panel 410-2 is no longer the optimal choice for receiving the transmission beam of the base station, and antenna panel 410-1 uses the receiving beam to receive DL RS beam 420-4, i.e., antenna panel 410-1 has a new association with DL RS beam 420-4. In this case, UE 120 may actively transmit an updated beam report to the base station, which may include an index of the new DL RS beam (e.g., “DL RS #4”), a channel quality measurement result of the new DL RS beam (e.g., “L1-RSRP #4” (measured by the new antenna panel 410-1)), and a panel state of the new antenna panel 410-1.

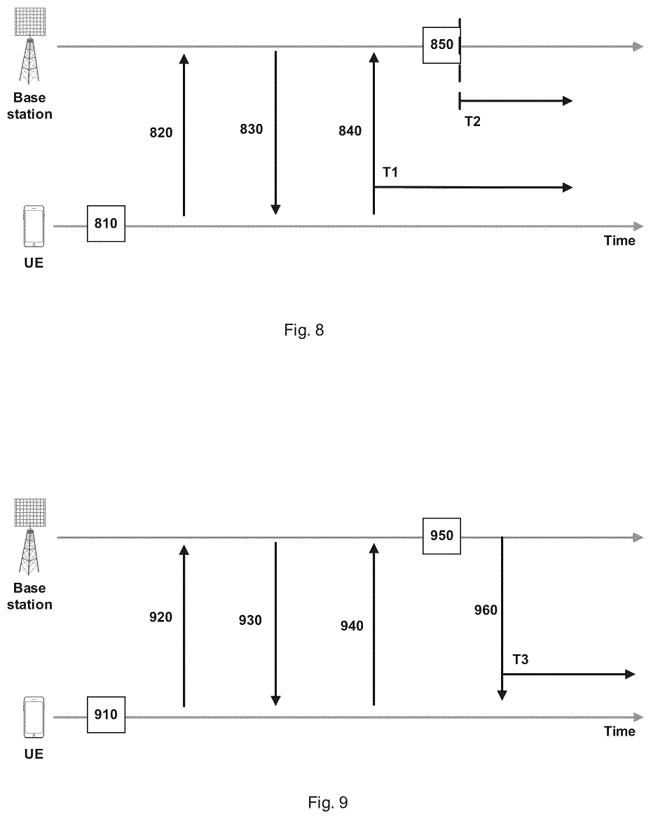

FIGS. 8 and 9 illustrate exemplary signaling flowcharts for transmitting updated beam reports, respectively, according to embodiments of the present disclosure, wherein FIG. 8 is based on uplink control information UCI and FIG. 9 is based on MAC CE.

In FIG. 8, at block 810, the UE is configured to perform the steps of step 630 in FIG. 6, i.e. to update the association between the antenna panel and the DL RS in response to detecting the first condition. Subsequently, at 820, the UE transmits an uplink scheduling request (SR) for a physical uplink control channel (PUCCH) or a physical uplink shared channel (PUSCH) to the base station. At 830, the UE receives an uplink authorization for a PUCCH or PUSCH from the base station. At 840, the UE transmits UCI on a PUCCH or PUSCH configured by the uplink authorization, which carries updated beam reports as described above. The UE considers, after transmitting UCI, that the updated antenna panel—DL RS association indicated in the updated beam report is applied from time T1. At 850, the base station processes the updated beam report to learn the updated association. Thus, from the perspective of the base station, starting at time T2, the updated antenna panel-DL RS association indicated in the updated beam report begins to be applied. The association updating method based on UCI shown in FIG. 8 has a low time delay, and is suitable for a scenario where, for example, a UE moves at a high speed resulting in that a panel state of an antenna panel changes rapidly.

In FIG. 9, at block 910, similar to block 810 of FIG. 8, the UE is configured to perform step 630 in FIG. 6, i.e., to update the association between the antenna panel and the DL RS in response to detecting the first condition. Subsequently, at 920, the UE transmits an uplink SR for PUSCH to the base station. At 930, the UE receives an uplink authorization for a PUSCH from a base station. At 940, the UE transmits a MAC CE on the PUSCH configured by the uplink authorization, the MAC CE carrying the updated beam report as described above. At 950, the base station processes the updated beam report to learn the updated association. At 960, the base station transmits an implicit HARQ for the MAC CE with the same HARQ process ID and a toggled new data indicator (toggled-NDI). After this implicit HARQ, both the base station and the UE consider that from this time (time T3), the updated antenna panel-DL RS association indicated in the updated beam report is applied. The association updating method based on MAC CE of FIG. 9 has higher reliability and is better compatible with existing communication standards or specifications.

In some embodiments, when the association updating method based on MAC CE shown in FIG. 9 is used, the updated beam report may have a different signaling format than the original beam report. Specifically, the updated beam report may include a panel state of the antenna panel and a corresponding updated uplink transmission configuration indicator (TCI) or a joint TCI.

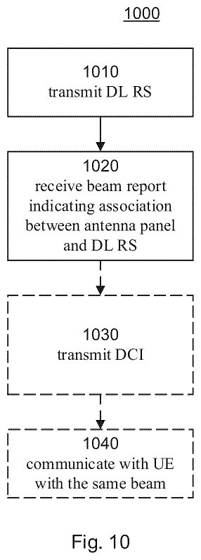

FIG. 10 illustrates an example flowchart of a method 1000 in accordance with an embodiment of the disclosure. Method 1000 may be used to implement a scheme of association of downlink reference signals with antenna panels in accordance with embodiments of the present disclosure. Method 1000 may be performed at the base station 110 side. Method 1000 may include steps 1010 to 1020.

In step 1010, base station 110 is configured to transmit one or more DL RSs to a UE comprising a plurality of antenna panels.

In some embodiments, each DL RS transmitted by the base station 110 may be a CSI-RS or an SSB. In some embodiments, the DL RSs transmitted by the base station 110 may be a CSI-RS resource set whose repetition parameter, Repetition, is configured to be ON. In some embodiments, the DL RSs received by UE 120 may be an SSB resource set. The base station may transmit the DL RSs in a periodic, semi-continuous, or aperiodic manner.

In step 1020, the base station 110 is configured to receive a beam report from the UE capable of indicating an association between the plurality of antenna panels and one or more DL RSs. Specifically, the beam report includes a panel state of at least one antenna panel among the plurality of antenna panels of the UE, an index of DL RS received via the at least one antenna panel, and a channel quality measurement result for the DL RS.

In some embodiments, the beam report includes, for each of all antenna panels of the UE, a corresponding panel state, an index of a received DL RS, and a channel quality measurement result for the DL RS. In other embodiments, the beam reports may be only directed to those antenna panels capable of receiving DL RSs, i.e., antenna panels whose panel state is not “inactivated”.

In some embodiments, the panel states may be any one of the following states: (1) “inactivated”; (2) ““partially activated for downlink measurements only”; (3) “partially activated for downlink measurements and data transmission only” and (4) “fully activated”. In some embodiments, the indexes of the DL RSs may include CRI, SSBRI, CSI-RS resource set ID, or SSB resource set ID. In some embodiments, the channel quality measurements for DL RSs are L1-RSRP or L1-SINR.

In some embodiments, the beam report signaling includes one or more entries, each entry corresponding to one antenna panel of the UE. Each entry includes an index of a DL RS received by a corresponding antenna panel, a channel quality measurement result of the DL RS, and a panel state of the antenna panel. For such beam report signaling, the base station can know that one DL RS is associated with one or more antenna panels, or that multiple DL RSs are associated with the same antenna panel and that the reported DL RS corresponds to the best channel quality measurement result.

In some embodiments, the beam report signaling includes a plurality of entries, each entry including an index of the DL RS, a channel quality measurement result of the DL RS, the same panel state, and a group label shared by the plurality of entries. For such beam report signaling, the base station can know that multiple DL RSs are associated with the same antenna panel.

In some embodiments, the beam report signaling includes at least one entry including a DL RS resource set ID, a channel quality measurement result, and a panel state. For such beam report signaling, the base station can know that one DL RS resource set is associated with one antenna panel.

In some embodiments, the beam report also includes a panel ID or label of the antenna panel, where the panel ID can reflect how the antenna panel is implemented, while the label does not reflect how the antenna panel is specifically implemented.

Optionally, base station 110 may be configured to continue to perform steps 1030 and 1040 after step 1020 to implement the scheme of antenna panel selection using the association between downlink reference signals and antenna panels according to the embodiment of the present disclosure.

In step 1030, the base station 110 is configured to transmit a DCI to the UE. The DCI indicates a selected DL RS of one or more DL RSs previously transmitted by a base station to a UE for channel sounding or beam management. As already described above in connection with FIG. 5, the selection of the DL RS may be performed by the base station based on the channel quality measurement results and the panel states in the beam report. In some embodiments, base station 110 may inform the UE of the DL RS selected by the base station through RRC configuration and downlink MAC signaling of TCI. Further, the base station 110 selects a specific TCI state from an alternative state subset corresponding to a CORESET (Control Resource Set) to be valid through MAC signaling. Thus, after receiving the MAC signaling, when the UE monitors a Physical Downlink Control Channel (PDCCH) or a Physical Downlink Shared Channel (PDSCH), it is considered that the PDCCH or the PUSCH uses a transmission beam used by a DL RS associated with the TCI specified by the MAC signaling.

In some embodiments, if the DL RS selected by the base station 110 is a DL RS resource set with the same beam direction, for example, a CSI-RS resource set or an SSB resource set of which the repetition parameter, Repetition, is configured to be ON, information of the DL RS resource set may be included in DCI, and information of any DL RSs in the reference signal resource set may also be included.

In step 1040, the base station 110 is configured to communicate with the UE using the same beam as the selected DL RS. The same beam may include the same transmission beam and, depending on the reciprocity of the uplink and downlink, the same beam may also include the same receiving beam.

It should be noted that the steps shown in FIG. 10 correspond to the method performed by the UE side shown in FIGS. 3 and 5, and if the technical details are omitted here, reference may be made to the corresponding description in FIGS. 3 and 5.

3. Association of Uplink Reference Signals with Antenna Panels

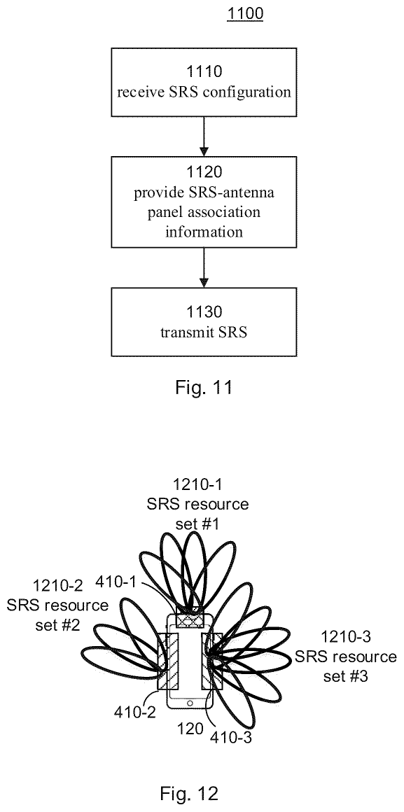

FIG. 11 shows an example flowchart of a method 1100 according to an embodiment of the disclosure. Method 1100 may be used to implement a scheme of association between uplink reference signals and antenna panels in accordance with embodiments of the present disclosure. Method 1100 may be performed at UE 120 side. Method 1100 may include steps 1110 to 1130.

In step 1110, the UE 120 is configured to receive sounding reference signal, SRS, configuration from a base station, the SRS configuration configuring a plurality of SRS resource sets for the UE. The SRS configuration may set the number of SRS resource sets and the number of SRSs in each SRS resource set. SRS configuration may configure the SRS to be transmitted in a periodic, semi-persistent, or aperiodic manner. Like CSI-RS, semi-persistent SRS requires MAC CEs for activation/deactivation, while aperiodic SRS requires DCI command for triggering.

In step 1120, the UE 120 is configured to provide SRS-antenna panel association information to the base station. The SRS-antenna panel association information may include a panel state of each of a plurality of antenna panels of the UE and an index of a SRS resource set to be transmitted using the antenna panel or an index of any SRS in the SRS resource set.

In one aspect, the SRS-antenna panel association information is the same as the beam report used in the scheme of association between downlink reference signals and antenna panels described above in that they both include the panel states and the indexes of the reference signals (DL RSs or SRSs).

Similar to the beam report, in some embodiments, the panel states in the SRS-antenna panel association information may be any one of the following states: (1) “inactivated”; (2) “partially activated for uplink measurements only”; (3) “partially activated only for uplink measurements and data transmission” and (4) “fully activated”.

Similar to the beam report, in some embodiments, the SRS-antenna panel association information may also include, for each antenna panel, a panel ID or label for the antenna panel.

On the other hand, the SRS-antenna panel association information is different from the beam report in that: firstly, in the scheme of association between uplink reference signals and antenna panels, the antenna panels are associated with SRS resource sets. Accordingly, the indexes of the SRS resource sets (e.g., resource set IDs) or the indexes of any SRS in the resource sets may be included in the SRS-antenna panel association information; secondly, channel quality measurement information may not be included in the scheme of association between the uplink reference signals and the antenna panels because channel measurements are performed at the base station for SRSs.

In some embodiments, UE Capability (Capability) information is reported to a base station when the UE establishes an initial connection with the base station. The UE capability information indicates the number of antenna panels that the UE has. In a further embodiment, the UE capability information also indicates a maximum number of beams supported by each antenna panel of the UE. After obtaining the capability information, the base station may configure the SRS resource sets accordingly. For example, the base station may configure the number of SRS resource sets to be equal to the number of antenna panels. In this case, the UE may allocate each SRS resource set to a different antenna panel such that the SRS resource sets correspond to the antenna panels on one-to-one basis. In some cases, the base station may also configure the number of SRSs in the SRS resource set not to exceed the maximum number of beams supported by the antenna panel.

FIG. 12 shows a schematic diagram of associating SRS resource sets with antenna panels, according to an embodiment of the disclosure. As shown in FIG. 12, antenna panel 410-1 is configured to transmit SRS resource set #1 1210-1, antenna panel 410-2 is configured to transmit SRS resource set #2 1210-2, and antenna panel 410-3 is configured to transmit SRS resource set #2 1210-3. For such association, the UE may set SRS-antenna panel association information to be reported to the base station, by way of non-limiting example only in a way as: Entry 1, including the panel state of antenna panel 410-1 and the index of SRS resource set 1210-1 (e.g., “SRS resource set #1”); Entry 2, including the panel state of antenna panel 410-2 and the index of SRS resource set 1210-2 (e.g., “SRS resource set #2”); and Entry 3, including the panel state of antenna panel 410-3 and the index of SRS resource set 1210-3 (e.g., “SRS resource set #3”).

Returning to FIG. 11, in step 1130, the UE 120 is configured to transmit, to the base station, SRSs in the associated SRS resource sets using the antenna panel based on the SRS-antenna panel association information. UE 120 may, in turn, use each antenna panel to transmit each SRS in the SRS resource set associated with that antenna panel to the base station for channel sounding by the base station. As will be described next, the SRS-based channel sounding results will be used by the base station for antenna panel selection in conjunction with SRS-antenna panel association information.

Similar to the scheme for antenna panel selection using beam report described in connection with FIG. 5, SRS-antenna panel association information may also be used for antenna panel selection. Similar to step 530, UE 120 may be configured to receive a DCI from a base station, where the DCI indicates a SRS resource set selected by the base station or a selected SRS in the SRS resource sets among SRSs previously sent to the base station for channel sounding. Similar to the selection of the DL RS in step 530, the selection of the SRS may be performed by the base station based on the measurement of the received SRSs and the panel states in the SRS-antenna panel association information. For example, the base station may select an SRS corresponding to the best measurement result from the SRSs. However, if the panel state of the antenna panel associated with the SRS with the best measurement is “partially activated for uplink measurements only”, i.e., the corresponding antenna panel does not support downlink or uplink data transmission, the base station may further select the SRS corresponding to suboptimal measurement and also check the corresponding panel state, and so on, until finding an SRS corresponding to an antenna panel capable of supporting downlink and/or uplink transmission. It can be appreciated that including the panel states in the SRS-antenna panel association information facilitates the base station to select a more suitable SRS, and thus a more suitable antenna panel. After selecting the SRS, the base station includes the SRS or information of the resource set in which the SRS is located in the DCI so as to be transmitted to the UE.

Similar to step 540, upon receiving the DCI, UE 120 is configured to communicate with the base station using the same antenna panel indicated in the SRS-antenna panel association information for transmitting the selected SRS resource set or the selected SRS. Specifically, after obtaining the information of the SRS selected by the base station from the received DCI, the UE 120 may know that the base station will use the receiving beam corresponding to the selected SRS in subsequent transmissions. Accordingly, the UE 120 also uses the same antenna panel previously used for transmitting the selected SRS to transmit uplink transmissions. Also, due to the reciprocity of the uplink and downlink, the UE 120 may also use the same antenna panel to receive downlink transmissions from the base station. It can be appreciated that since the association between the SRS and the antenna panel is indicated in the SRS-antenna panel association information, the base station makes the panel selection indirectly by indicating the SRS.

Reporting of the SRS-antenna panel association information updates is similar to reporting of the beam report updates described above in connection with FIGS. 6-9. As mentioned above, movement, communication due to factors such as rotation, congestion, MPE or power control of the UE, the state of the antenna panel of the UE may change, and the association relationship between the antenna panels and the SRSs that has been reported to the base station is no longer applicable. The UE may associate with the SRS using the new antenna panel and may actively initiate reporting of an association update between the SRSs and the antenna panels.

In some embodiments, UE 120 may be configured to update an association between an SRS resource set and an antenna panel in response to detecting a first condition and then transmit the updated SRS-antenna panel association information to the base station. In particular, the first condition indicates that the association between the antenna panels and the SRS resource sets should change. In some embodiments, the first condition may include a change in a panel state of an antenna panel associated with an SRS resource set. For example, the antenna panel may be changed to support only uplink measurements and not uplink or downlink data transmissions.

In some embodiments, updating the association between the SRS resource sets and the antenna panels may include planning to transmit SRSs in the original SRS resource set using the new antenna panel.

In some embodiments, the updated SRS-antenna panel association information may have the same signaling format as the original SRS-antenna panel association information. Specifically, the updated SRS-antenna panel association information may include a panel state of the new antenna panel and an index of an original SRS resource set to be transmitted using the new antenna panel or an index of any SRS in the original SRS resource set.

In other embodiments, the updated SRS-antenna panel association information may have a different signaling format than the original SRS-antenna panel association information. In particular, the updated SRS-antenna panel association information may include the panel state of the new antenna panel and a corresponding updated uplink TCI or joint TCI.

The method of transmitting the updated SRS-antenna panel association information further includes both a UCI-based approach and a MAC CE-based approach. Similar to FIG. 8, in the UCI based method, the UE is configured to transmit an uplink SR to the base station and, after getting a scheduling authorization, transmit updated SRS-antenna panel association information in UCI using a scheduled PUSCH or PUCCH channel. Similar to FIG. 9, in the MAC CE based approach, the UE is configured to transmit an uplink SR to the base station and, after getting a scheduling authorization, to transmit updated SRS-antenna panel association information in the MAC CE using a scheduled PUSCH and finally to end with receiving implicit HARQ from the base station, wherein the implicit HARQ has the same HARQ process ID and a toggled new data indication NDI. Further details regarding the two methods can be found in the corresponding description with reference to FIGS. 8 and 9, and are not repeated herein.

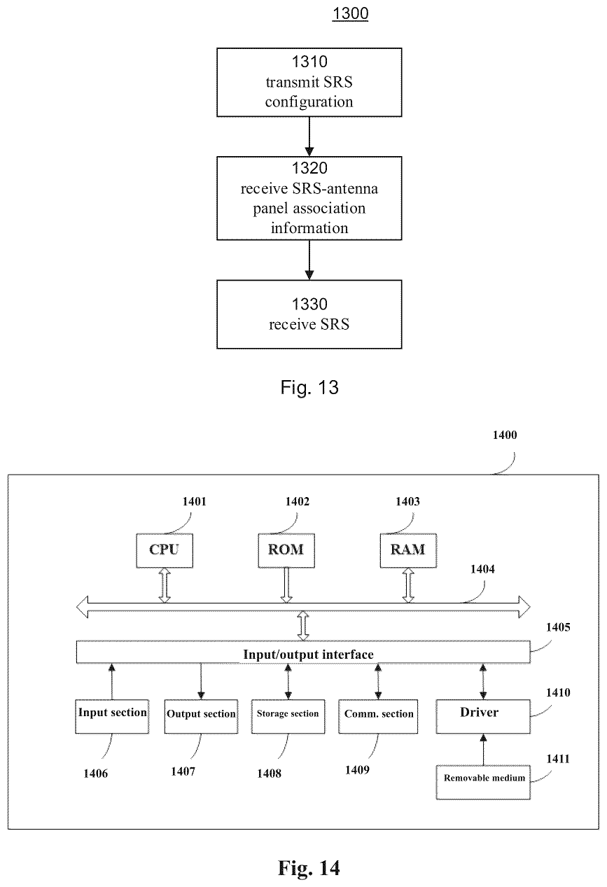

FIG. 13 illustrates an example flowchart showing a method 1300 according to an embodiment of the disclosure. Method 1300 may be used to implement a scheme of association between uplink reference signals and antenna panels according to embodiments of the present disclosure. Method 1300 may be performed at the base station 110 side. Method 1300 may include steps 1310 to 1330. It can be seen that method 1300 for the base station 110 side corresponds to method 1100 for the UE side. Therefore, for the functions as mentioned specific details of the features or generally herein, refer to the introduction of methodology 1100.

In step n 110 is configured to transmit to the UE sounding reference signal, SRS, configuration that configures the UE with a plurality of SRS resource sets. The SRS configuration may set the number of SRS resource sets. Further, the SRS configuration may also set the number of SRSs in each SRS resource set.

In step 1320, the base station 110 is configured to receive SRS-antenna panel association information from the UE. The SRS-antenna panel association information may include, for each of a plurality of antenna panels of the UE, a panel state and an index of an SRS resource set to be transmitted using the antenna panel or an index of any SRS in the SRS resource set.

In step 1330, the base station 110 is configured to receive an SRS in the SRS resource set from the UE for uplink channel sounding.

Similarly, for the content of performing, at the base station side, antenna panel selection by using SRS-antenna panel association information and updating the SRS-antenna panel association information, reference can be made to a corresponding scheme described for the UE side, which is not described herein again.

Embodiments of an electronic device and method for associating an antenna panel of a UE with a reference signal in a wireless communication system and updating the association according to the present disclosure have been described above. In the embodiment of the present disclosure, the UE actively reports the panel states of the antenna panels to the base station, so that the base station can be assisted to make more appropriate panel selection, delay or communication quality reduction caused by inappropriate selection is reduced, and user experience is ensured. In addition, by reporting the association between the antenna panel and the reference signal to the base station by the UE, the base station can be facilitated to indirectly indicate the antenna panel that the UE should use by indicating the reference signal, thereby making the selection of the antenna panel faster. In addition, the UE actively updates the association between the antenna panel and the reference signal, so that the base station can respond to the state change of the UE in time, so as to guarantee the communication quality as much as possible.

It should be noted that the above description is merely exemplary. Embodiments of the present disclosure may also be implemented in any other suitable manner that may still achieve the advantageous effects obtained by embodiments of the present disclosure. Moreover, embodiments of the present disclosure are equally applicable to other similar application examples, and the advantageous effects obtained by embodiments of the present disclosure can still be achieved.

It should be understood that machine-executable instructions in a machine-readable storage medium or program product according to embodiments of the present disclosure may be configured to perform operations corresponding to the above-described apparatus and method embodiments. Embodiments of the machine-readable storage medium or program product will be apparent to those skilled in the art when reference is made to the embodiments of the above apparatus and method, which will not be repeated. Machine-readable storage media and program products for carrying or including the machine-executable instructions described above are also within the scope of the present disclosure. Such storage media may include, but is not limited to, floppy disks, optical disks, magneto-optical disks, memory cards, memory sticks, and the like.

In addition, it should be understood that the above-described series of processes and apparatuses may also be implemented by software and/or firmware. In the case of implementation by software and/or firmware, a program constituting the software is installed from a storage medium or a network to a computer having a dedicated hardware structure, such as a general-purpose personal computer 1400 shown in FIG. 14, which is capable of executing various functions and the like when various programs are installed. FIG. 14 is a block diagram showing an example structure of a personal computer of an information processing apparatus employable in the embodiment according to the present disclosure. In one example, the personal computer may correspond to the above-described exemplary transmitting device or terminal-side electronic device according to the present disclosure.

In FIG. 14, a central processing unit (CPU) 1401 executes various processes in accordance with a program stored in a read only memory (ROM) 1402 or a program loaded from a storage portion 1408 to a random access memory (RAM) 1403. In the RAM 1403, data necessary when the CPU 1401 executes various processes and the like is also stored as necessary.

The CPU 1401, ROM 1402, and RAM 1403 are connected to each other via a bus 1404. An input/output interface 1405 is also connected to the bus 1404.

The following components are connected to the input/output interface 1405: an input section 1406 including a keyboard, a mouse, and the like; an output section 1407 including a display such as a cathode ray tube (CRT), a liquid crystal display (LCD), and the like, and a speaker and the like; a storage section 1408 including a hard disk and the like; and a communication section 1409 including a network interface card such as a LAN card, a modem, or the like. The communication section 1409 performs communication processing via a network such as the internet.

A driver 1410 is also connected to the input/output interface 1405 as necessary. A removable medium 1411 such as a magnetic disk, an optical disk, a magneto-optical disk, a semiconductor memory, or the like is mounted on the drive 1410 as necessary, so that the computer program read out therefrom is installed into the storage section 1408 as necessary.

In the case where the above-described series of processes is realized by software, a program constituting the software is installed from a network such as the internet or a storage medium such as the removable medium 1411.

It should be understood by those skilled in the art that such a storage medium is not limited to the removable medium 1411 shown in FIG. 14 in which the program is stored, distributed separately from the apparatus to provide the program to the user. Examples of the removable medium 1411 include a magnetic disk (including a floppy disk (registered trademark)), an optical disk (including a compact disk read only memory (CD-ROM) and a Digital Versatile Disk (DVD)), a magneto-optical disk (including a Mini Disk (MD) (registered trademark)), and a semiconductor memory. Alternatively, the storage medium may be the ROM 1402, the hard disk included in the storage section 1408, or the like, in which the programs are stored, and which are distributed to the user together with the apparatus including them.

### 4. APPLICATION EXAMPLES

The techniques of the present disclosure can be applied to a variety of products.

For example, the control-side electronic device according to an embodiment of the present disclosure may be implemented as or included in various control devices/base stations. For example, the transmitting device and the terminal device according to the embodiments of the present disclosure may be implemented as or included in various terminal devices.

For example, the control devices/base stations mentioned in the present disclosure may be implemented as any type of base station, e.g., eNBs, such as macro eNBs and small eNBs. Small eNBs may be eNBs that cover cells smaller than macro cells, such as pico eNBs, micro eNBs, and home (femto) eNBs. For another example, the control devices/base stations may be implemented as gNBs, such as macro gNBs and small gNBs. The small gNBs may be gNBs covering a cell smaller than a macro cell, such as a pico gNBs, micro gNBs, and home (femto) gNBs. Instead, the base station may be implemented as any other type of base station, such as a NodeB and a Base Transceiver Station (BTS). The base station may include: a main body (also referred to as a base station apparatus) configured to control wireless communication; and one or more Remote Radio Heads (RRHs) disposed at a place different from the main body. In addition, various types of terminals, which will be described below, can each operate as a base station by temporarily or semi-persistently performing a base station function.

For example, the terminal device mentioned in the present disclosure, in some embodiments, may be implemented as a mobile terminal such as a smart phone, a tablet Personal Computer (PC), a notebook PC, a portable game terminal, a portable/dongle-type mobile router and a digital camera, or a vehicle-mounted terminal such as a car navigation device. The terminal device may also be implemented as a terminal (also referred to as a Machine Type Communication (MTC) terminal) that performs machine-to-machine (M2M) communication. Further, the terminal device may be a wireless communication module (such as an integrated circuit module including a single chip) mounted on each of the above-described terminals.

Application examples according to the present disclosure will be described below with reference to the drawings.

### [Example Concerning Base Station]

It should be understood that the term base station in the disclosure has its full breadth in its ordinary meaning and includes at least a wireless communication station used to facilitate communications as part of a wireless communication system or radio system. Examples of base stations may be, for example, but are not limited to the following: the base station may be one or both of a Base Station Transceiver (BTS) and a Base Station Controller (BSC) in a GSM system, which may be one or both of a Radio Network Controller (RNC) and a Node B in a WCDMA system, may be an eNB in LTE and LTE-Advanced systems, or may be a corresponding network Node in future communication systems (e.g., gNB, eLTE eNB, etc., as may occur in a 5G communication system). Part of the functions in the base station of the present disclosure may also be implemented as an entity having a control function for communication in the D2D, M2M, and V2V communication scenarios, or as an entity functioning as spectrum coordination in the cognitive radio communication scenario.

### First Example

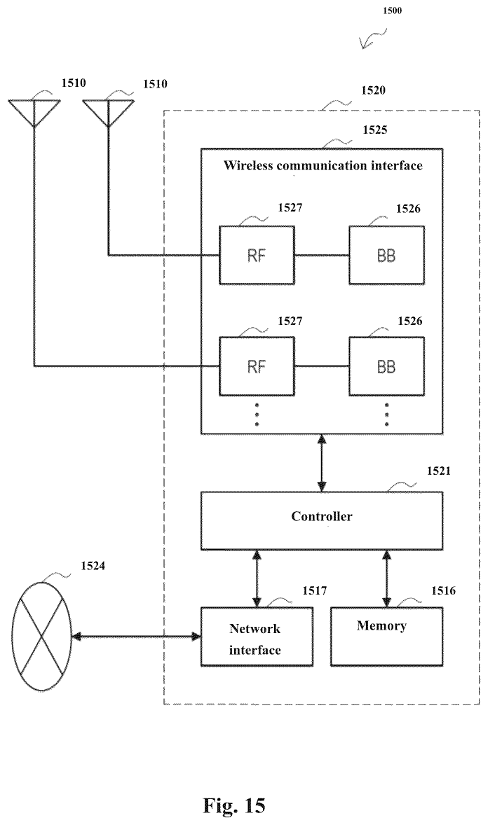

FIG. 15 is a block diagram illustrating a first example of a schematic configuration of a gNB to which the technique of the present disclosure can be applied. The gNB 1500 includes a plurality of antennas 1510 and a base station apparatus 1520. The base station apparatus 1520 and each antenna 1510 may be connected to each other via an RF cable. In one implementation, the gNB 1500 (or the base station equipment 1520) here may correspond to the control-side electronic device described above.

Each of the antennas 1510 includes a single or multiple antenna elements, such as multiple antenna elements included in a multiple-input multiple-output (MIMO) antenna, and is used for transmitting and receiving wireless signals by the base station apparatus 1520. As shown in FIG. 15, the gNB 1500 may include a plurality of antennas 1510. For example, the plurality of antennas 1510 may be compatible with multiple frequency bands used by the gNB 1500.

Base station equipment 1520 comprises a controller 1521, memory 1522, a network interface 1517, and a wireless communication interface 1525.

The controller 1521 may be, for example, a CPU or a DSP, and operates various functions of higher layers of the base station apparatus 1520. For example, the controller 1521 determines the position information of a target terminal device among at least one terminal device according to the positioning information of at least one terminal device on the terminal side in the wireless communication system and the specific position configuration information of at least one terminal device, which are acquired by the wireless communication interface 1525. The controller 1521 may have a logic function of performing the following control: such as radio resource control, radio bearer control, mobility management, access control and scheduling. This control may be performed in connection with a nearby gNB or core network node. The memory 1522 includes a RAM and a ROM, and stores programs executed by the controller 1521 and various types of control data (such as a terminal list, transmission power data, and scheduling data).

The network interface 1523 is a communication interface for connecting the base station apparatus 1520 to a core network 1524. The controller 1521 may communicate with a core network node or another gNB via the network interface 1517. In this case, the qNB 1500 and the core network node or other gNBs may be connected to each other through logical interfaces such as an S1 interface and an X2 interface. The network interface 1523 may also be a wired communication interface or a wireless communication interface for a wireless backhaul. If the network interface 1523 is a wireless communication interface, the network interface 1523 may use a higher frequency band for wireless communication than the frequency band used by the wireless communication interface 1525.

The wireless communication interface 1525 supports any cellular communication scheme, such as Long Term Evolution (LTE) and LTE-Advanced, and provides wireless connectivity to terminals located in the cell of the gNB 1500 via the antenna 1510. The wireless communication interface 1525 may generally include, for example, a baseband (BB) processor 1526 and RF circuitry 1527. The BB processor 1526 may perform, for example, encoding/decoding, modulation/demodulation and multiplexing/demultiplexing, and perform various types of signal processing of layers such as L1, Medium Access Control (MAC), Radio Link Control (RLC), and Packet Data Convergence Protocol (PDCP). In place of the controller 1521, the BB processor 1526 may have a part or all of the above-described logic functions. The BB processor 1526 may be a memory that stores a communication control program, or a module that includes a processor and associated circuitry configured to execute programs. The update program can cause the function of the BB processor 1526 to change. The module may be a card or blade that is inserted into a slot of the base station equipment 1520. Alternatively, the module may be a chip mounted on a card or blade. Meanwhile, the RF circuit 1527 may include, for example, a mixer, a filter, and an amplifier, and transmit and receive a wireless signal via the antenna 1510. Although FIG. 15 shows an example in which one RF circuit 1527 is connected to one antenna 1510, the present disclosure is not limited to this illustration, and one RF circuit 1527 may be connected to a plurality of antennas 1510 at the same time.

As shown in FIG. 15, the wireless communication interface 1525 may include a plurality of BB processors 1526. For example, the plurality of BB processors 1526 can be compatible with the plurality of frequency bands used by the gNB 1500. As shown in FIG. 15, the wireless communication interface 1525 may include a plurality of RF circuits 1527. For example, the plurality of RF circuits 1527 may be compatible with multiple antenna elements.

Although FIG. 15 shows an example in which the wireless communication interface 1525 includes multiple BB processors 1526 and multiple RF circuits 1527, the wireless communication interface 1525 may also include a single BB processor 1526 or a single RF circuit 1527.

### Second Example

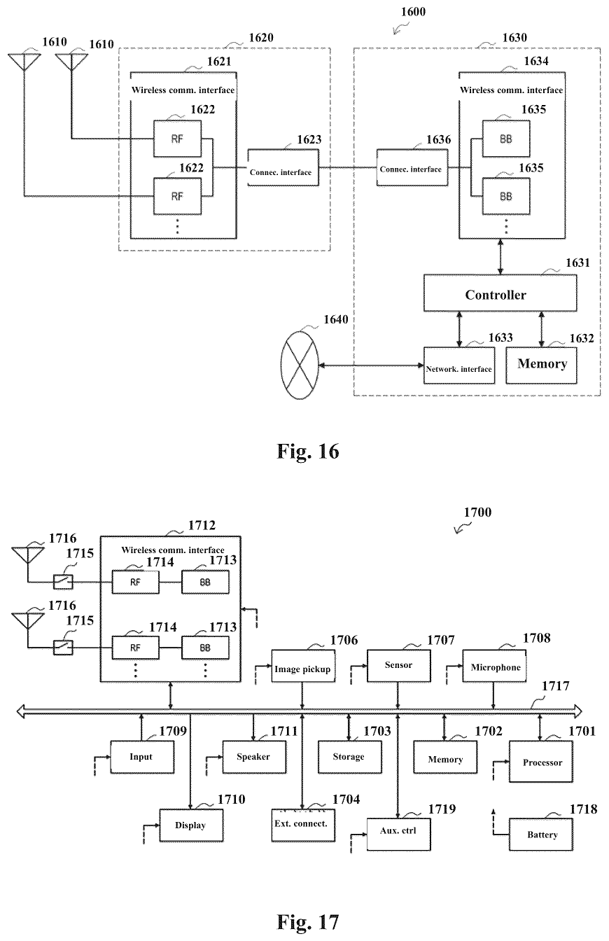

FIG. 16 is a block diagram illustrating a second example of a schematic configuration of a gNB to which the technique of the present disclosure can be applied. The gNB 1600 includes multiple antennas 1610, RRH 1620, and base station equipment 1630. RRH 1620 and each antenna 1610 may be connected to each other via an RF cable. Base station equipment 1630 and RRH 1620 may be connected to each other via a high speed line such as a fiber optic cable. In one implementation, the gNB 1600 (or the base station equipment 1630) here may correspond to the control-side electronic device described above.

Each of the antennas 1610 includes a single or multiple antenna elements (such as multiple antenna elements included in a MIMO antenna) and is used for transmitting and receiving wireless signals by the RRH 1620. As shown in FIG. 16, the gNB 1600 may include multiple antennas 1610. For example, multiple antennas 1610 can be compatible with multiple frequency bands used by the gNB 1600.

Base station equipment 1630 includes controller 1631, memory 1632, network interface 1633, wireless communication interface 1634, and connection interface 1636. The controller 1631, memory 1632, and network interface 1633 are the same as the controller 1521, memory 1522, and network interface 1523 described with reference to FIG. 15.

Wireless communication interface 1634 supports any cellular communication scheme (such as LTE and LTE-Advanced) and provides wireless communication via RRH 1620 and antenna 1610 to terminals located in a sector corresponding to RRH 1620. The wireless communication interface 1634 generally includes, for example, a BB processor 1635. The BB processor 1635 is identical to the BB processor 1526 described with reference to FIG. 15, except that the BB processor 1635 is connected to the RF circuitry 1622 of the RRH 1620 via a connection interface 1636. As shown in FIG. 16, the wireless communication interface 1634 may include a plurality of BB processors 1635. For example, the plurality of BB processors 1635 can be compatible with the plurality of frequency bands used by the gNB 1600. Although FIG. 16 shows an example in which the wireless communication interface 1634 includes multiple BB processors 1635, the wireless communication interface 1634 may also include a single BB processor 1635.

Connection interface 1636 is an interface used to connect base station equipment 1630 (wireless communication interface 1634) to RRH 1620. Connection interface 1636 may also be a communications module for communications in the high speed line described above that connects base station equipment 1630 (wireless communications interface 1634) to RRH 1620.

RRH 1620 includes connection interface 1623 and wireless communication interface 1621.

Connection interface 1623 is an interface for connecting RRH 1620 (wireless communication interface 1621) to base station equipment 1630. Connection interface 1623 may also be a communications module for communications in the high speed lines described above.

Wireless communication interface 1621 transmits and receives wireless signals via antenna 1610. Wireless communication interface 1621 typically includes, for example, RF circuitry 1622. The RF circuitry 1622 may include, for example, mixers, filters, and amplifiers, and transmits and receives wireless signals via the antenna 1610. Although FIG. 16 shows an example in which one RF circuit 1622 is connected to one antenna 1610, the present disclosure is not limited to this illustration, and one RF circuit 1622 may be connected to a plurality of antennas 1610 simultaneously.

As shown in FIG. 16, wireless communication interface 1621 may include a plurality of RF circuits 1622. For example, multiple RF circuits 1622 may support multiple antenna elements. Although FIG. 16 illustrates an example in which wireless communication interface 1621 includes multiple RF circuits 1622, wireless communication interface 1621 may include a single RF circuit 1622.

### [Examples Relating to User Equipment/Terminal Equipment]

### First Example

FIG. 17 is a block diagram illustrating an example of a schematic configuration of a communication device 1700 (e.g., smartphone, contactor, etc.) to which the techniques of the disclosure may be applied. The communication device 1700 includes a processor 1701, a memory 1702, a storage 1703, an external connection interface 1704, a camera 1706, a sensor 1707, a microphone 1708, an input device 1709, a display device 1710, a speaker 1711, a wireless communication interface 1712, one or more antenna switches 1715, one or more antennas 1716, a bus 1717, a battery 1718, and an auxiliary controller 1719. The communication device 1700 (or the processor 1701) herein may correspond to the transmitting device or the terminal-side electronic device described above in one implementation.

The processor 1701 may be, for example, a CPU or a system on chip (SoC), and controls functions of an application layer and other layers of the communication device 1700. The memory 1702 includes a RAM and a ROM, and stores data and programs executed by the processor 1701. The storage 1703 may include a storage medium such as a semiconductor memory and a hard disk. The external connection interface 1704 is an interface for connecting an external device such as a memory card and a Universal Serial Bus (USB) device to the communication device 1700.

The image pickup device 1706 includes an image sensor such as a Charge Coupled Device (CCD) and a Complementary Metal Oxide Semiconductor (CMOS), and generates a captured image. The sensor 1707 may include a set of sensors such as a measurement sensor, a gyro sensor, a geomagnetic sensor, and an acceleration sensor. The microphone 1708 converts sound input to the communication device 1700 into an audio signal. The input device 1709 includes, for example, a touch sensor, a keypad, a keyboard, a button, or a switch configured to detect a touch on the screen of the display device 1710, and receives an operation or information input from a user. The display device 1710 includes a screen such as a Liquid Crystal Display (LCD) and an Organic Light Emitting Diode (OLED) display, and displays an output image of the communication device 1700. The speaker 1711 converts an audio signal output from the communication device 1700 into sound.

The wireless communication interface 1712 supports any cellular communication scheme (such as LTE and LTE-Advanced) and performs wireless communication. The wireless communication interface 1712 generally includes, for example, a BB processor 1713 and RF circuitry 1714. The BB processor 1713 can perform, for example, encoding/decoding, modulation/demodulation, and multiplexing/demultiplexing, and perform various types of signal processing for wireless communication. Meanwhile, the RF circuit 1714 may include, for example, a mixer, a filter, and an amplifier, and transmit and receive a wireless signal via the antenna 1716. The wireless communication interface 1712 may be one chip module on which the BB processor 1713 and the RF circuit 1714 are integrated. As shown in FIG. 17, the wireless communication interface 1712 may include a plurality of BB processors 1713 and a plurality of RF circuits 1714. Although FIG. 17 shows an example in which the wireless communication interface 1712 includes multiple BB processors 1713 and multiple RF circuits 1714, the wireless communication interface 1712 may include a single BB processor 1713 or a single RF circuit 1714.

Further, the wireless communication interface 1712 may support another type of wireless communication scheme, such as a short-range wireless communication scheme, a near field communication scheme, and a wireless Local Area Network (LAN) scheme, in addition to the cellular communication scheme. In this case, the wireless communication interface 1712 may include the BB processor 1713 and the RF circuit 1714 for each wireless communication scheme.

Each of the antenna switches 1715 switches a connection destination of the antenna 1716 between a plurality of circuits (e.g., circuits for different wireless communication schemes) included in the wireless communication interface 1712.

Each of the antennas 1716 includes a single or multiple antenna elements (such as multiple antenna elements included in a MIMO antenna) and is used for transmitting and receiving wireless signals via wireless communication interface 1712. As shown in FIG. 17, the communication device 1700 may include multiple antennas 1716. Although FIG. 17 illustrates an example in which the communication device 1700 includes multiple antennas 1716, the communication device 1700 may include a single antenna 1716.

Further, the communication device 1700 may include an antenna 1716 for each wireless communication scheme. In this case, the antenna switch 1715 may be omitted from the configuration of the communication device 1700.

The bus 1717 connects the processor 1701, the memory 1702, the storage device 1703, the external connection interface 1704, the image pickup device 1706, the sensor 1707, the microphone 1708, the input device 1709, the display device 1710, the speaker 1711, the wireless communication interface 1712, and the auxiliary controller 1719 to each other. The battery 1718 provides power to the various blocks of the communication device 1700 shown in FIG. 17 via a power feed, which is partially shown in the figure as a dashed line. The secondary controller 1719 operates the minimum necessary functions of the communication device 1700, for example, in a sleep mode.

### Second Example

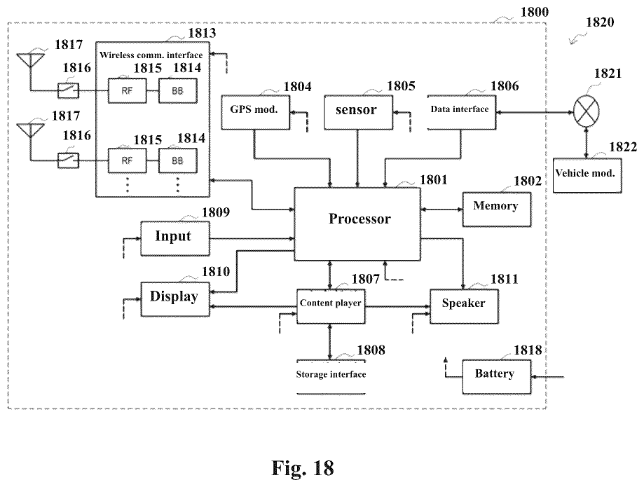

FIG. 18 is a block diagram showing an example of a schematic configuration of a car navigation device 1800 to which the technique of the present disclosure can be applied. The car navigation device 1800 includes a processor 1801, memory 1802, a Global Positioning System (GPS) module 1804, a sensor 1805, a data interface 1806, a content player 1807, a storage medium interface 1808, an input device 1809, a display device 1810, a speaker 1811, a wireless communication interface 1813, one or more antenna switches 1816, one or more antennas 1817, and a battery 1818. In one implementation, the car navigation device 1800 (or the processor 1801) herein may correspond to a transmitting device or a terminal-side electronic device.

The processor 1801 may be, for example, a CPU or a SoC, and controls a navigation function and another function of the car navigation device 1800. The memory 1802 includes a RAM and a ROM, and stores data and programs executed by the processor 1801.

The GPS module 1804 measures the position (such as latitude, longitude, and altitude) of the car navigation device 1800 using GPS signals received from GPS satellites. The sensor 1805 may include a set of sensors such as gyro sensors, geomagnetic sensors, and air pressure sensors. The data interface 1806 is connected to, for example, an in-vehicle network 1821 via a terminal not shown, and acquires data generated by a vehicle (such as vehicle speed data).

A content player 1807 reproduces content stored in a storage medium (such as a CD and a DVD) inserted into the storage medium interface 1808. The input device 1809 includes, for example, a touch sensor, a button, or a switch configured to detect a touch on the screen of the display device 1810, and receive an operation or information input from a user. The display device 1810 includes a screen such as an LCD or OLED display, and displays an image of a navigation function or reproduced content. The speaker 1811 outputs the sound of the navigation function or the reproduced content.

The wireless communication interface 1813 supports any cellular communication scheme (such as LTE and LTE-Advanced) and performs wireless communication. The wireless communication interface 1813 generally includes, for example, a BB processor 1814 and RF circuitry 1815. The BB processor 1814 may perform, for example, encoding/decoding, modulation/demodulation, and multiplexing/demultiplexing, and perform various types of signal processing for wireless communication. Meanwhile, the RF circuit 1815 may include, for example, a mixer, a filter, and an amplifier, and transmit and receive a wireless signal via the antenna 1817. The wireless communication interface 1813 may also be one chip module on which the BB processor 1814 and RF circuit 1815 are integrated. As shown in FIG. 18, the wireless communication interface 1813 may include a plurality of BB processors 1814 and a plurality of RF circuits 1815. Although FIG. 18 shows an example in which the wireless communication interface 1813 includes multiple BB processors 1814 and multiple RF circuits 1815, the wireless communication interface 1813 may also include a single BB processor 1814 or a single RF circuit 1815.

Further, the wireless communication interface 1813 may support another type of wireless communication scheme, such as a short-range wireless communication scheme, a near field communication scheme, and a wireless LAN scheme, in addition to the cellular communication scheme. In this case, the wireless communication interface 1813 may include a BB processor 1814 and a RF circuit 1815 for each wireless communication scheme.

Each of the antenna switches 1816 switches a connection destination of the antenna 1817 between a plurality of circuits (such as circuits for different wireless communication schemes) included in the wireless communication interface 1813.

Each of the antennas 1817 includes a single or multiple antenna elements (such as multiple antenna elements included in a MIMO antenna) and is used for transmitting and receiving wireless signals for the wireless communication interface 1813. As shown in FIG. 18, the car navigation device 1800 may include a plurality of antennas 1817. Although FIG. 18 shows an example in which the car navigation device 1800 includes a plurality of antennas 1817, the car navigation device 1800 may also include a single antenna 1817.

Further, the car navigation device 1800 may include an antenna 1817 for each wireless communication scheme. In this case, the antenna switch 1816 may be omitted from the configuration of the car navigation device 1800.

The battery 1818 provides power to the various blocks of the car navigation device 1800 shown in FIG. 18 via a power feed, which is partially shown in the figure as a dashed line. The battery 1818 accumulates electric power supplied from the vehicle.

The techniques of the disclosure may also be implemented as an in-vehicle system (or vehicle) 1820 including one or more blocks of a car navigation device 1800, an in-vehicle network 1821, and a vehicle module 1822. The vehicle module 1822 generates vehicle data (such as vehicle speed, engine speed, and fault information) and outputs the generated data to the on-board network 1821.

The exemplary embodiments of the present disclosure are described above with reference to the drawings, but the present disclosure is of course not limited to the above examples. Various changes and modifications may be made by those skilled in the art within the scope of the appended claims, and it should be understood that these changes and modifications naturally fall within the technical scope of the present disclosure.

It should be understood that machine-executable instructions in a machine-readable storage medium or program product according to embodiments of the present disclosure may be configured to perform operations corresponding to the above-described embodiments of the apparatus and method. Embodiments of the machine-readable storage medium or program product will be apparent to those skilled in the art with reference to the embodiments of the apparatus and method, and therefore are not repeated. Machine-readable storage media and program products for carrying or including the machine-executable instructions described above are also within the scope of the present disclosure. Such storage media may include, but is not limited to, floppy disks, optical disks, magneto-optical disks, memory cards, memory sticks, and the like.

In addition, it should be understood that the above-described series of processes and devices may also be implemented by software and/or firmware. In the case of implementation by software and/or firmware, respective programs constituting the respective software are stored in a storage medium of the relevant device, and when the programs are executed, various functions can be performed.

For example, in the above embodiments, a plurality of functions included in one unit may be implemented by separate devices. Alternatively, a plurality of functions implemented by a plurality of units in the above embodiments may be implemented by separate devices, respectively. In addition, one of the above functions may be implemented by a plurality of units. Needless to say, such a configuration is included in the technical scope of the present disclosure.

In this specification, the steps described in the flowcharts include not only the processes performed in time series in the described order but also the processes performed in parallel or individually without necessarily being performed in time series. Further, even in the steps processed in time series, needless to say, the order can be changed appropriately.

### 5. EXEMPLARY EMBODIMENT IMPLEMENTATION OF THE PRESENT DISCLOSURE

In accordance with embodiments of the present disclosure, various exemplary implementations of implementing the concepts of the present disclosure are conceivable, including but not limited to:

Embodiment 1, an electronic device for a user equipment UE side, the UE including a plurality of antenna panels, the electronic device comprising:
a processing circuit configured to:
   receive one or more downlink reference signals, DL RSs, from a base station via the plurality of antenna panels; and
   provide a beam report to a base station, the beam report indicating an association of the plurality of antenna panels with the one or more DL RSs, wherein the beam report comprises:
      a panel state of at least one antenna panel of the plurality of antenna panels;
      an index of at least one of the one or more DL RSs received via the at least one antenna panel; and
      a channel quality measurement for the at least one DL RS.

Embodiment 2, the electronic device of Embodiment 1, wherein each of the one or more DL RSs is selected from the group consisting of:
a channel state information reference signal (CSI-RS);
a synchronization signal block (SSB);
a CSI-RS resource set with a repetition parameter, Repetition, being configured to be ON; and
a SSB resource set.

Embodiment 3, the electronic device of Embodiment 1, wherein the beam report further comprises a panel ID or label to identify the at least one panel.

Embodiment 4, the electronic device of Embodiment 1, wherein the panel state indicates that a respective antenna panel is in one of the following states:
inactivated;
partially activated for downlink measurements only;
partially activated for downlink measurements and data transmission only; or
fully activated.

Embodiment 5, the electronic device of Embodiment 1, wherein the UE is configured to receive each of the one or more DL RSs with a different antenna panel of the at least one antenna panel, wherein the beam report comprises, for each of the at least one antenna panel:
a panel state of the antenna panel;
an index of a DL RS associated with the antenna panel; and
a channel quality measurement result for the DL RS associated with the antenna panel.

Embodiment 6, the electronic device of Embodiment 1, wherein the UE is configured to receive a plurality of DL RSs of the one or more DL RSs via a same antenna panel from the at least one antenna panel, wherein the beam report comprises:
a panel state of the same antenna panel;
an index of a DL RS having the best channel quality measurement result among the plurality of DL RSs; and
the best channel quality measurement result.

Embodiment 7, the electronic device of Embodiment 1, wherein the UE is configured to receive a plurality of DL RSs of the one or more DL RSs via a same antenna panel of the at least one antenna panel, wherein the beam report comprises, for each DL RS in the plurality of DL RSS:

a panel state of the same antenna panel;

a group label shared by the plurality of DL RSS;

an index of the DL RS; and

channel quality measurement results for the DL RS.

Embodiment 8, the electronic device of Embodiment 1, wherein the UE is configured to receive one of the one or more DL RSs via a plurality of antenna panels from the at least one antenna panel, wherein the beam report comprises:
an index of the one DL RS;
a respective panel state of each of the plurality of antenna panels and a respective channel quality measurement result for the one DL RS measured by the antenna panel.

Embodiment 9, the electronic device of Embodiment 1, wherein the processing circuitry is further configured to:
receive DCI from a base station, an DCI indicating a selected DL RS of the one or more DL RSs;
communicate with the base station via the same panel indicated as one in the beam report for receiving the selected DL RS.

Embodiment 10, the electronic device of Embodiment 1, wherein the channel quality measurement result includes at least one of L1-RSRP or L1-SINR.

Embodiment 11, the electronic device of Embodiment 1, wherein the processing circuitry is further configured to:
update the association between the plurality of antenna panels and the one or more DL RSs in response to a detection of a first condition indicating that the association of the plurality of antenna panels with the one or more DL RSs should change; and
transmit an updated beam report to the base station to indicate an updated association of the plurality of antenna panels with the one or more DL RSs.

Embodiment 12, the electronic device of Embodiment 11, wherein the first condition includes a change in a panel state of the at least one antenna panel.

Embodiment 13, the electronic device of Embodiment 11, wherein the first condition includes a channel quality measurement result for the at least one DL RS being less than a predetermined threshold.

Embodiment 14, the electronic device of Embodiment 11, wherein the updated beam report has the same signaling format as the beam report.

Embodiment 15, the electronic device of Embodiment 11, wherein in order to transmit the updated beam report, the processing circuitry is further configured to:
transmit an uplink scheduling request to the base station; and
transmit the updated beam report in uplink control information, UCI, via a scheduled PUSCH or PUCCH channel in response to receiving an uplink scheduling authorization from a base station.

Embodiment 16, the electronic device of Embodiment 11, wherein in order to transmit the updated beam report, the processing circuitry is further configured to:
transmit an uplink scheduling request to the base station;
transmit the updated beam report in a MAC CE via a scheduled PUSCH in response to receiving an uplink scheduling authorization from the base station; and
receive implicit HARQ from the base station, the implicit HARQ having a same HARQ process ID and a toggled new data indication (NDI).

Embodiment 17, the electronic device of Embodiment 16, wherein the updated beam report has a different signaling format than the beam report, the updated beam report comprising:
a panel state of at least one of the plurality of antenna panels; and
an updated uplink TCI or joint TCI associated with the at least one antenna panel.

Embodiment 18, a method performed at a user equipment UE side, comprising:
receiving one or more downlink reference signals, DL RSS, from a base station through the plurality of antenna panels; and
providing a beam report to the base station, wherein the beam report comprises:
   a panel state of at least one of the plurality of antenna panels;
   an index of at least one of the one or more DL RSS received via the at least one antenna panel; and
   a channel quality measurement result for the at least one DL RS.

Embodiment 19, an electronic device for a base station, BS, side, comprising:
a processing circuit configured to:
   transmit one or more downlink reference signals, DL RS, to a user equipment, UE, comprising a plurality of antenna panels; and
   receive a beam report from the UE, wherein the beam report comprises:
      a panel state of at least one of the plurality of antenna panels;
      an index of at least one of the one or more DL RSs received via the at least one antenna panel; and
      a channel quality measurement result for the at least one DL RS.

Embodiment 20, the electronic device of Embodiment 19, wherein each of the one or more DL RSs is selected from the group consisting of:
a channel state information reference signal (CSI-RS);
a synchronization signal block (SSB);
a CSI-RS resource set with the repetition parameter, Repetition, being configured to be ON; and
a SSB resource set.

Embodiment 21, the electronic device of Embodiment 19, wherein the beam report further comprises a panel ID or label to identify the at least one antenna panel.

Embodiment 22, the electronic device of Embodiment 19, wherein the panel state indicates that a respective antenna panel is in one of the following states:
inactivated;
partially activated for downlink measurements only;
partially activated for downlink measurements and data transmission only; or
fully activated.

Embodiment 23, the electronic device of Embodiment 19, wherein in a case where the UE is configured to receive each of the one or more DL RSs with a different antenna panel of the at least one antenna panel, the beam report comprises, for each of the at least one antenna panel:
a panel state of the antenna panel;
an index of a DL RS associated with the antenna panel; and
channel quality measurement results for DL RS associated with the antenna panel.

Embodiment 24, the electronic device of Embodiment 19, wherein in a case where the UE is configured to receive a plurality of DL RSs of the one or more DL RSs via a same one of the at least one antenna panel, the beam report comprises:
a panel state of the same antenna panel;
an index of a DL RS having a best channel quality measurement result among the plurality of DL RSs;
and the best channel quality measurement result.

Embodiment 25, the electronic device of Embodiment 19, wherein in a case where the UE is configured to receive a plurality of DL RSs of the one or more DL RSs via a same antenna panel of the at least one antenna panel, the beam report comprises, for each of the plurality of DL RSS:
a panel state of the same antenna panel;
a group label shared by the plurality of DL RSs;
an index of the DL RS; and
channel quality measurement results for the DL RS.

Embodiment 26, the electronic device of Embodiment 19, wherein in a case where the UE is configured to receive one of the one or more DL RSs via a plurality of antenna panels of the at least one antenna panel, the beam report comprises:
an index of the one DL RS;
a respective panel state of each of the plurality of antenna panels and a respective channel quality measurement result for the one DL RS measured by the antenna panel.

Embodiment 27, the electronic device of Embodiment 19, wherein the processing circuitry is further configured to:
transmit, to the UE, an DCI indicating a selected DL RS of the one or more DL RSS;
communicate with the UE via the same beam as the selected DL RS.

Embodiment 28, the electronic device of Embodiment 27, wherein the processing circuitry is further configured to:
determine the particular DL RS from at least one of the channel quality measurement result and the panel state in the beam report.

Embodiment 29, the electronic device of Embodiment 19, wherein the channel quality measurement result comprises at least one of L1-RSRP or L1-SINR.

Embodiment 30, a method performed at a base station BS side, comprising:
transmitting one or more downlink reference signals, DL RSs, to a user equipment, UE, comprising a plurality of antenna panels; and
receiving a beam report from the UE, wherein the beam report comprises:
   a panel state of at least one antenna panel of the plurality of antenna panels;
   an index of at least one of the one or more DL RSS received via the at least one antenna panel; and
   a channel quality measurement result for the at least one DL RS.

Embodiment 31, an electronic device for a user equipment UE side, the UE including multiple antenna panels, the electronic device comprising:

a processing circuit configured to:

receive, from a base station, sounding reference signal, SRS, configuration that configures a plurality of SRS resource sets for the UE;
provide SRS-antenna panel association information to the base station, the SRS-antenna panel association information comprising:
   a panel state of each of the plurality of antenna panels; and
   an index of a respective SRS resource set to be transmitted via the antenna panel or an index of any SRS in the respective SRS resource set to be transmitted via the antenna panel; and
transmit, to the base station, an SRS in a respective SRS resource set via at least one of the plurality of antenna panels based on the SRS-antenna panel association information.

Embodiment 32, the electronic device of Embodiment 31, wherein the SRS-antenna panel association information further comprises, for each antenna panel, a panel ID or label of the antenna panel.

Embodiment 33, the electronic device of Embodiment 31, wherein the processing circuitry is further configured to:
receive an DCI from the base station, the DCI indicating a selected SRS resource set of the plurality of SRS resource sets or a selected SRS in the selected SRS resource set;
communicate with the base station via the same antenna panel as one indicated in the SRS-antenna panel association information for transmitting the selected SRS resource set or the selected SRS.

Embodiment 34, the electronic device of Embodiment 31, wherein the panel state indicates that a respective antenna panel is in one of the following states:
inactivated;
partially activated for uplink measurements only;
partially activated for uplink measurements and data transmission only; or fully activated.

Embodiment 35, the electronic device of Embodiment 31, the processing circuitry further configured to:
update the association of the plurality of antenna panels with the plurality of SRS resource sets in response to a detection of a first condition indicating that an association of the plurality of antenna panels with the plurality of SRS resource sets should change; and
transmit updated SRS-antenna panel association information to the base station to indicate the updated association of the plurality of antenna panels with the plurality of SRS resource sets.

Embodiment 36 the electronic device of embodiment 31, wherein the first condition comprises a change in a panel state of the at least one antenna panel.

Embodiment 37, the electronic device of Embodiment 31, wherein the updated SRS-antenna panel association information has the same signaling format as the SRS-antenna panel association information.

Embodiment 38, the electronic device of Embodiment 31, wherein to transmit the updated SRS-antenna panel association information, the processing circuitry is further configured to:
transmit an uplink scheduling request to the base station; and
transmit the updated SRS-antenna panel association information in uplink control information, UCI, via a scheduled PUSCH or PUCCH in response to receiving an uplink scheduling authorization from a base station.

Embodiment 39, the electronic device of embodiment 31, wherein to transmit the updated beam report, the processing circuitry is further configured to:
transmit an uplink scheduling request to the base station;
transmit the updated SRS-antenna panel association information in a MAC CE via a scheduled PUSCH in response to receiving an uplink scheduling authorization from the base station; and
receive implicit HARQ from the base station, an implicit HARQ having a same HARQ process ID and a toggled new data indication (NDI).

Embodiment 40, the electronic device of Embodiment 31, wherein the updated SRS-antenna panel association information has panel a different signaling format than the SRS-antenna association information, and wherein the updated SRS-antenna panel association information comprises:
a panel state of at least one antenna panel of the plurality of antenna panels; and
an updated uplink TCI or joint TCI associated with the at least one antenna panel.

Embodiment 41, a method performed at a user equipment, UE, side, the UE comprising a plurality of antenna panels, the method comprising:
receiving, from a base station, sounding reference signal, SRS, configuration that configures a plurality of SRS resource sets for the UE;
providing SRS-antenna panel association information to a base station, the SRS-antenna panel association information comprising:
   a panel state of each of the plurality of antenna panels; and
   an index of a respective SRS resource set to be transmitted using the antenna panel or an index of any SRS in the respective SRS resource set to be transmitted using the antenna panel; and
transmitting, to the base station, an SRS in a respective SRS resource set via at least one of the plurality of antenna panels based on the SRS-antenna panel association information.

Embodiment 42, an electronic device for a base station BS side, comprising:
a processing circuit configured to:
   transmit sounding reference signal (SRS) configuration to a user equipment (UE), the SRS configuration configuring a plurality of SRS resource sets for the UE;
   receive SRS-antenna panel association information from the UE, the SRS-antenna panel association information including:
      a panel state of each of a plurality of antenna panels of the UE; and
      an index of a respective SRS resource set to be transmitted via the antenna panel or an index of any SRS in the respective SRS resource set to be transmitted via the antenna panel; and
   receive, from the UE, one or more SRSs from the plurality of SRS resource sets.

Embodiment 43 the electronic device according to Embodiment 42, wherein the SRS-antenna panel association information further comprises, for each antenna panel, a panel ID or label of the antenna panel.

Embodiment 44, the electronic device according to Embodiment 42, wherein the processing circuitry is further configured to:
transmit an DCI to the UE, the DCI indicating a selected SRS resource set from the plurality of SRS resource sets or a selected SRS from the selected SRS resource set;
communicate with the UE via the same antenna panel as one indicated in the SRS-antenna panel association information for transmitting the selected SRS resource set or the selected SRS.

Embodiment 45, the electronic device according to Embodiment 42, wherein the panel state indicates that a respective antenna panel is in one of the following states:
inactivated;
partially activated for uplink measurements only;
partially activated for uplink measurements and data transmission only; or fully activated.

Embodiment 46, a method performed at a base station, BS, side, the method comprising:
transmitting sounding reference signal (SRS) configuration to a User Equipment (UE), the SRS configuration configuring a plurality of SRS resource sets for the UE;
receiving SRS-antenna panel association information from the UE, the SRS-antenna panel association information including:
   a panel state of each of a plurality of antenna panels of the UE; and
   an index of a respective SRS resource set to be transmitted via the antenna panel or an index of any SRS in the respective SRS resource set to be transmitted via the antenna panel; and
receiving, from the UE, one or more SRSs from the plurality of SRS resource sets.

Embodiment 47, a computer-readable storage medium storing one or more instructions that, when executed by one or more processing circuits of an electronic device, cause the electronic device to perform the method of any of embodiments 18, 30, 41 or 46.

Embodiment 48, a computer program product comprising one or more instructions that when executed by one or more processing circuits of an electronic device, cause the electronic device to perform the method of any of embodiments 18, 30, 41 or 46.

Although the present disclosure and its advantages have been described in detail, it should be understood that various changes, substitutions and alterations can be made herein without departing from the spirit and scope of the disclosure as defined by the appended claims. Furthermore, the terms “comprise”, “include”, or any other variation thereof, in the embodiments of the present disclosure are intended to cover a non-exclusive inclusion, such that a process, method, article, or apparatus that comprises a list of elements does not include only those elements but may include other elements not expressly listed or inherent to such process, method, article, or apparatus. Without further limitation, an element defined by the phrase “comprising a . . . ” does not exclude the presence of other identical elements in the process, method, article, or apparatus that comprises the element.

Although some specific embodiments of the present disclosure have been described in detail, it should be understood by those skilled in the art that the above embodiments are illustrative only and do not limit the scope of the present disclosure. Those skilled in the art will appreciate that the above-described embodiments may be combined, modified or substituted without departing from the scope and spirit of the present disclosure. The scope of the present disclosure is defined by the appended claims.

1. An electronic device for a user equipment (UE) side, the UE including a plurality of antenna panels, the electronic device comprising:
a processing circuit configured to:
receive, from a base station, one or more downlink reference signals (DL RSs), via the plurality of antenna panels; and
provide, to the base station, a beam report indicating an association of the plurality of antenna panels with the one or more DL RSs, wherein the beam report comprises:
a panel state of at least one antenna panel of the plurality of antenna panels:
an index of at least one DL RS of the one or more DL RSs received via the at least one antenna panel; and
a channel quality measurement result for the at least one DL RS.

2. The electronic device of claim 1, wherein each of the one or more DL RSs is selected from a group comprising:
a channel state information reference signal (CSI-RS):
a synchronization signal block (SSB):
a CSI-RS resource set with a repetition parameter, Repetition, being configured to be ON; and
a SSB resource set.

3. The electronic device of claim 1, wherein the beam report further comprises a panel ID or label to identify the at least one panel.

4. The electronic device of claim 1, wherein the panel state indicates that a respective antenna panel is in one of the following states:
inactivated:
partially activated for downlink measurements only:
partially activated for downlink measurements and data transmission only: or fully activated.

5. The electronic device of claim 1, wherein the UE is configured to receive each of the one or more DL RSs with a different antenna panel of the at least one antenna panel,
wherein the beam report comprises, for each of the at least one antenna panel:
a panel state of the antenna panel:
an index of a DL RS associated with the antenna panel; and
a channel quality measurement result for the DL RS associated with the antenna panel.

6. The electronic device of claim 1, wherein the UE is configured to receive a plurality of DL RSs of the one or more DL RSs via a same antenna panel of the at least one antenna panel,
wherein the beam report comprises:
a panel state of the same antenna panel:
an index of a DL RS having the best channel quality measurement result among the plurality of DL RSs; and
the best channel quality measurement result.

7. The electronic device of claim 1, wherein the UE is configured to receive a plurality of DL RSs of the one or more DL RSs via a same antenna panel of the at least one antenna panel,
wherein the beam report comprises, for each of the plurality of DL RSs:
a panel state of the same antenna panel:
a group label shared by the plurality of DL RSs:
an index of the DL RS; and
a channel quality measurement result for the DL RS.

8. The electronic device of claim 1, wherein the UE is configured to receive one DL RS of the one or more DL RSs via a plurality of antenna panels of the at least one antenna panel,
wherein the beam report comprises:
an index of the one DL RS:
a respective panel state of each of the plurality of antenna panels and a respective channel quality measurement result for the one DL RS measured by the antenna panel.

9. The electronic device of claim 1, wherein the processing circuitry is further configured to:
receive, from a base station, an DCI indicating a selected DL RS of the one or more DL RSs:
communicate with the base station via the same panel as one indicated in the beam report for receiving the selected DL RS.

10.-48. (canceled)

49. The electronic device of claim 1, the processing circuit is further configured to:
in response to a detection of a first condition indicating that the association of the plurality of antenna panels with the one or more DL RSs should change, update the association of the plurality of antenna panels with the one or more DL RSs; and
transmit, to the base station, an updated beam report to indicate an updated association of the plurality of antenna panels with the one or more DL RSs.

50. The electronic device of claim 49, wherein the first condition comprises a change in a panel state of the at least one antenna panel or a channel quality measurement result for the at least one DL RS being less than a predetermined threshold.

51. The electronic device of claim 49, wherein to transmit the updated beam report, the processing circuitry is further configured to:
transmit, to the base station, an uplink scheduling request; and
in response to receiving, from the base station, an uplink scheduling authorization, transmit the updated beam report in uplink control information (UCI) via a scheduled physical uplink shared channel (PUSCH) or physical uplink control channel (PUCCH).

52. The electronic device of claim 49, wherein to transmit the updated beam report, the processing circuitry is further configured to:
transmit, to the base station, an uplink scheduling request:
in response to receiving, from the base station, an uplink scheduling authorization, transmit the updated beam report in a MAC CE via a scheduled PUSCH; and
receive, from the base station, an implicit HARQ having a same HARQ process ID and a toggled new data indication (NDI).

53. The electronic device of claim 52, wherein the updated beam report has a different signaling format than the beam report, the updated beam report comprising:
a panel state of at least one of the plurality of antenna panels; and
an updated uplink TCI or joint TCI associated with the at least one antenna panel.

54. An electronic device for a base station, BS, side, comprising:
a processing circuit configured to:
transmit, to a user equipment, UE, comprising a plurality of antenna panels, one or more downlink reference signals, DL RSs; and
receive a beam report from the UE, wherein the beam report comprises:
a panel state of at least one of the plurality of antenna panels:
an index of at least one DL RS of the one or more DL RSs received via the at least one antenna panel; and
a channel quality measurement result for the at least one DL RS.

55. The electronic device of claim 54, wherein the processing circuitry is further configured to:
transmit, to the UE, an DCI indicating a selected DL RS of the one or more DL RSs:
communicate with the UE via the same beam as the selected DL RS.

56. The electronic device of claim 55, wherein the processing circuitry is further configured to:
determine the selected DL RS from at least one of a channel quality measurement result and a panel state in the beam report.

57. An electronic device for a user equipment, UE, side, the UE including a plurality of antenna panels, the electronic device comprising:
a processing circuit configured to:
receive, from a base station, sounding reference signal, SRS, configuration that configures a plurality of SRS resource sets for the UE:
provide, to the base station, SRS-antenna panel association information comprising:
a panel state of each of the plurality of antenna panels; and
an index of a respective SRS resource set to be transmitted via the antenna panel or an index of any SRS in the respective SRS resource set to be transmitted via the antenna panel; and
transmit, to the base station and via at least one of the plurality of antenna panels, an SRS in a respective SRS resource set based on the SRS-antenna panel association information.

58. The electronic device of claim 57, wherein the SRS-antenna panel association information further comprises, for each antenna panel, a panel ID or label for the antenna panel.

59. The electronic device of claim 57, wherein the processing circuitry is further configured to:
receive, from the base station, an DCI indicating a selected SRS resource set of the plurality of SRS resource sets or a selected SRS in the selected SRS resource set;
communicate with the base station via the same antenna panel as one indicated in the SRS-antenna panel association information for transmitting the selected SRS resource set or the selected SRS.
